(19) United States
(12) Patent Application Publication
(10) Pub. No.: US 2024/0385575 A1
(43) Pub. Date: Nov. 21, 2024

(54) BIOPROCESS CONTROLLER WITH INTELLIGENT GATEWAY

(71) Applicant: Life Technologies Corporation, Carlsbad, CA (US)

(72) Inventors: Charles Kamas, Carlsbad, CA (US); Jignesh Patel, Carlsbad, CA (US)

(21) Appl. No.: 18/692,257

(22) PCT Filed: Aug. 22, 2022
(86) PCT No.: PCT/US2022/041104

§ 371 Date: Mar. 14, 2024

Related U.S. Application Data
(60) Provisional application No. 63/244,866, filed on Sep. 16, 2021.

(51) Int. Cl. G05B 13/02; H04L 12/66

(52) U.S. Cl. CPC G05B 13/024; H04L 12/66

(57) ABSTRACT

A bioprocessing control system can include an intelligent gateway. The gateway can receive, from a controller, a request for data associated with the plurality of bioprocessing instruments including a primary data set and a secondary data set. The primary data set includes a block of primary data measured by the plurality of bioprocessing instruments. The secondary data set has a lower priority than the primary data set. The gateway can cause the controller to control the bioprocessing instrument by at least: sending, to the controller in response to the request, the block of primary data. The gateway can send, to the controller during the sending the block of primary data and in response to the request, a portion of the secondary data set, thereby reducing a load on the controller.

### CROSS-REFERENCE TO RELATED APPLICATIONS

The present application claims priority to U.S. Provisional Application No. 63/244,866, filed Sep. 16, 2021, and entitled “Bioprocess Controller with Intelligent Gateway,” the entirety of which is incorporated by reference herein.

### FIELD

This disclosure relates generally to bioprocessing systems.

### BACKGROUND

Bioprocessing systems generally include a bioprocess controller to which various bioprocess instruments including, for example, sensors, pumps, mass flow controllers, reaction containers, agitators, temperature control devices, and/or other instruments related to bioproduction are connected. Those instruments are generally connected through the bioprocess controller to a main automation control system. Once such example of an automation control system that has been adapted for bioprocessing systems is the DeltaV™ control system from Emerson Electric Co.

In a bioprocessing system, the main control system generally communicates with at least some of the instruments in the system using a standard communication protocol suited for automated systems. A commonly used communication protocol is the Modbus protocol.

### SUMMARY

Systems, methods, and articles of manufacture, including computer program products, are provided for an intelligent gateway and/or controller for a bioprocessing control system. In one aspect, there is provided a system. The system can include at least one data processor and at least one memory. The at least one memory can store instructions that result in operations when executed by the at least one data processor. The operations can include: receiving, from a controller configured to control a bioprocessing instrument of a plurality of bioprocessing instruments, a request for data associated with the plurality of bioprocessing instruments. The data includes a primary data set including a block of primary data measured by the plurality of bioprocessing instruments and a secondary data set having a lower priority than the primary data set. The operations further include causing the controller to control the bioprocessing instrument for processing a cell culture containing one or more target biological components by at least: sending, to the controller in response to the request, the block of primary data. The operations further include sending, to the controller during the sending the block of primary data and in response to the request, a portion of the secondary data set, thereby reducing a load on the controller.

In some aspects, the secondary data set is stored across a plurality of pages, and a page of the plurality of pages contains the portion of the secondary data set.

In some aspects, the request includes an identifier identifying the page of the plurality of pages.

In some aspects, the block of primary data includes: a first parameter measured by at least one of the plurality of bioprocessing instruments. The first parameter is mapped to a first communication protocol address. The block of primary data further includes a second parameter measured by at least one of the plurality of bioprocessing instruments. The second parameter is mapped to a second communication protocol address. The first parameter and the second parameter impact operation of the bioprocessing instrument.

In some aspects, the portion of the secondary data set includes secondary data corresponding to at least two of the plurality of bioprocessing instruments, and the portion of the secondary data set is mapped to a single communication protocol address.

In some aspects, the request is a first request. The operations further include receiving, from the controller, a second request for data associated with the plurality of bioprocessing instruments after the first request. The operations further include sending, to the controller in response to the second request, a second portion of the secondary data set. The second request includes a second identifier associated with the second portion.

In some aspects, the operations further include: further causing the controller to control the bioprocessing instrument by at least: sending, to the controller in response to the second request, a second block of primary data measured by the plurality of bioprocessing instruments after the sending the block of primary data. The second portion of the secondary data set is sent during the sending of the second block of primary data.

In some aspects, the second request is received at a predetermined interval after the first request.

In some aspects, the primary data set includes operational data associated with the plurality of bioprocessing instruments. The secondary data set includes instrument data associated with the plurality of bioprocessing instruments.

In some aspects, the operational data includes at least one parameter measured by the plurality of bioprocessing instruments that impacts operation of at least one of the plurality of bioprocessing instruments.

In some aspects, the instrument data includes instrument information about at least one of the plurality of bioprocessing instruments.

In some aspects, the priority of the primary data set and the secondary data set is predetermined.

In some aspects, the operations further include receiving the primary data set and the secondary data set from the plurality of bioprocessing instruments. The operations further include storing the primary data set in a primary data register. The storing includes mapping a unique communication protocol address to each parameter in the block of primary data of the primary data set. The operations further include storing the secondary data set in a secondary data register. The storing includes mapping a single communication protocol address to the portion of the secondary data set. The portion of the secondary data set corresponds to at least two bioprocessing instruments of the plurality of bioprocessing instruments.

In some aspects, the operations further include receiving the primary data set and the secondary data set from the plurality of bioprocessing instruments. At least a portion of the primary data set or the secondary data set has a first unit of measurement. The operations may include converting the first unit of measurement to a second unit of measurement prior to sending the block of primary data or the secondary data set to the controller.

In one aspect, there is provided a system. The system can include at least one data processor and at least one memory. The at least one memory can store instructions that result in operations when executed by the at least one data processor. The operations can include: sending a request for data associated with a plurality of bioprocessing instruments. The data includes a primary data set including a block of primary data measured by the plurality of bioprocessing instruments and a secondary data set having a lower priority than the primary data set. The operations include receiving, in response to the request, the block of primary data. The operations include receiving, in response to the request and during the receiving the block of primary data, a portion of the secondary data set, thereby reducing a computing load for processing the data associated with the plurality of bioprocessing instruments. The operations include controlling operation of a bioprocessing instrument of the plurality of bioprocessing instruments to process a cell culture containing one or more target biological components based at least on the received block of primary data.

In some aspects, the secondary data set is stored across a plurality of pages, and wherein a page of the plurality of pages contains the portion of the secondary data set.

In some aspects, the request includes an identifier identifying the page of the plurality of pages.

In some aspects, the block of primary data includes: a first parameter measured by at least one of the plurality of bioprocessing instruments. The first parameter is mapped to a first communication protocol address. The block of primary data further includes a second parameter measured by at least one of the plurality of bioprocessing instruments. The second parameter is mapped to a second communication protocol address. The first parameter and the second parameter impact operation of the bioprocessing instrument.

In some aspects, the portion of the secondary data set includes secondary data corresponding to at least two of the plurality of bioprocessing instruments, and the portion of the secondary data set is mapped to a single communication protocol address.

In some aspects, the request is a first request. The operations further includes: sending a second request for data associated with the plurality of bioprocessing instruments after the first request, and receiving, in response to the second request, a second portion of the secondary data set. The second request includes a second identifier associated with the second portion.

In some aspects, the operations further include receiving, in response to the second request, a second block of primary data measured by the plurality of bioprocessing instruments. The second portion of the secondary data is received during the receiving of the second block of primary data. The operations include further controlling operation of the bioprocessing instrument based on the second block of primary data.

In some aspects, the second request is sent at a predetermined interval after the first request.

In some aspects, the primary data set includes operational data associated with the plurality of bioprocessing instruments and the secondary data set includes instrument data associated with the plurality of bioprocessing instruments.

In some aspects, the operational data includes at least one parameter measured by the plurality of bioprocessing instruments that impacts operation of at least one of the plurality of bioprocessing instruments.

In some aspects, the instrument data includes instrument information about at least one of the plurality of bioprocessing instruments.

In some aspects, the priority of the primary data set and the secondary data set is predetermined.

In some aspects, the controlling includes sending a control signal to the bioprocessing instrument.

A gateway device for a bioprocess controller in a bioprocessing system includes one or more processors, a control system data communication link configured to be communicatively coupled to a control system to communicate between the gateway and the control system using a set of data addresses of a first communication protocol, a plurality of instrument data communication links configured to be communicatively coupled to a plurality of bioprocessing instruments to communicate bioprocessing instrument data between the plurality of bioprocessing instruments and the gateway device, and one or more computer readable media with instructions stored thereon that, when executed by the one or more processors, cause the one or more processors to perform operations including: exchanging the instrument data between the gateway and the control system using the set of data addresses wherein a first subset of the set of data addresses is used to exchange primary instrument data having a first priority level and a second subset of the set data addresses is used to exchange secondary instrument data having a second priority level.

In some aspects, the first subset of data addresses is mapped to the primary instrument data such that one protocol data address is mapped to one instrument data element.

In some aspects, the second subset of data addresses is mapped to the secondary instrument data such that one protocol data address is mapped to more than one instrument data elements by using an address identifier external to the first communication protocol.

In some aspects, the plurality of bioprocessing instruments include sensors that sense conditions in one or more bioprocess containers.

In some aspects, the plurality of sensors include a temperature sensor, a pH sensor, or an oxygen sensor.

In some aspects, the plurality of sensors include a scale.

In some aspects, the plurality of sensors further include a pressure sensor.

In some aspects, the plurality of bioprocessing instruments include a temperature control unit and pumps.

In some aspects, the plurality of bioprocessing instruments include a temperature control unit, pumps, mass flow controllers, or an agitator.

In some aspects, the first communication protocol is a Modbus communication protocol and the set of data addresses are Modbus registers.

In some aspects, the first subset of data addresses is used to exchange secondary data including instrument data elements that are required to be exchanged less frequently than primary data including other instrument data elements.

In some aspects, the gateway is housed in the bioprocess controller.

In some aspects, a plurality of instrument control boards are housed in the bioprocess controller and are communicatively coupled between the gateway device and a plurality of bioprocessing instruments.

In some aspects, the gateway device is housed outside of the bioprocess controller.

According to some aspects, a method of controlling a process in a bioprocessing system includes receiving a primary data set of bioprocess instrument data elements and a secondary data set of bioprocess instrument data elements at a gateway device, storing the primary set of bioprocess instrument data elements in a primary data registry at the gateway device, where the primary data registry includes a set of primary data addresses, of a first commination protocol, that are equal to the number of bioprocess instrument data elements in the primary data set, storing the secondary data set of bioprocess instrument data elements in a secondary data registry at the gateway device, where the secondary data registry includes a set of secondary data addresses that are less than the number of bioprocess instrument data elements in the secondary data set, and sending the primary data set and the secondary data set to a controller configured to control a bioprocess instrument in the bioprocessing system.

In some aspects, each of the secondary data addresses are mapped to more than one bioprocess instrument data element in the secondary data set.

In some aspects, the set of secondary data addresses are mapped to more than one bioprocess instrument data element in the secondary data set using an address identifier external to the first communication protocol.

In some aspects, the primary data set includes operational data.

In some aspects, the operational data includes pH data, dissolved oxygen data, pressure data, temperature data, rpm data, power data, mass data, volumetric flow rate data, density data, or foam content data.

In some aspects, the secondary data set includes device identification data or device state data.

In some aspects, the device identification data includes manufacturer information, manufacture date, model number, serial number, device color, or device version.

In some aspects, the device state data includes device setup data, device configuration data, device calibration data, device power state, or device connectivity state.

In some aspects, the primary data set is sent to the controller more frequently than the secondary data set.

In some aspects, the primary data set is sent to the controller continuously over a time period.

According to some aspects, a method of controlling a process in a bioprocessing system includes receiving, at a control system a primary data set of bioprocess instrument data elements from a primary data registry, receiving, at the control system, a secondary data set of bioprocess instrument data elements from a secondary data registry, comparing, at the control system, an instrument data element of the primary data set to an instrument set point, outputting, by the control system, an instrument control signal based on the result of the comparing step, and sending the control signal to a gateway device in the bioprocessing system.

In some aspects, the primary data registry includes a set of primary data addresses of a first communication protocol that are equal to the number of bioprocess instrument data elements in the primary data set.

In some aspects, the secondary data registry includes a set of secondary data addresses that are less than the number of bioprocess instrument data elements in the secondary data set.

In some aspects, the primary data set is received at the control system more frequently than the secondary data set.

In some aspects, the primary data set is received at the control system continuously over a time period.

In some aspects, the primary data set includes operational data.

In some aspects, the operational data includes pH data, dissolved oxygen data, pressure data, temperature data, rpm data, power data, mass data, volumetric flow rate data, density data, or foam content data.

In some aspects, the secondary data set includes device identification data or device state data.

In some aspects, the device identification data includes manufacturer information, manufacture date, model number, serial number, device color, or device version.

In some aspects, the device state data includes device setup data, device configuration data, device calibration data, device power state, device connectivity state.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that can include one or more processors and one or more memories coupled to the one or more processors. A memory, which can include a non-transitory computer-readable or machine-readable storage medium, can include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a block diagram of a bioprocessing system in accordance with exemplary implementations.

FIG. 2 is a block diagram of a bioprocessing system in accordance with exemplary implementations.

FIG. 3 is a block diagram of a bioprocessing system in accordance with exemplary implementations.

FIG. 4 is a block diagram of data mappings between instrument data elements and protocol data addresses in accordance with exemplary implementations.

FIG. 5 illustrates data set structures in accordance with exemplary implementations.

FIG. 6 is a swim-lane diagram showing a process for implementing an intelligent gateway, consistent with implementations of the current subject matter.

FIG. 7 is a block diagram of a control system architecture in accordance with exemplary implementations.

FIG. 8 illustrates a process flow implemented by a control system for processing secondary read data in accordance with exemplary implementations.

FIG. 9 illustrates a process flow implemented by a control system for processing secondary write data in accordance with exemplary implementations.

FIG. 10 illustrates a process flow implemented by an intelligent gateway device for processing secondary read data in accordance with exemplary implementations.

FIG. 11 illustrates a process flow implemented by an intelligent gateway device for processing secondary write data in accordance with exemplary implementations.

FIG. 12 is a block diagram of a computer system implementing bioprocess systems and intelligent gateway devices in accordance with exemplary implementations.

When practical, similar reference numbers denote similar structures, features, or elements.

### DETAILED DESCRIPTION

The various implementations are described more fully hereinafter with reference to the accompanying Figures, which form a part hereof, and which show, by way of illustration, specific examples of the implementations. This disclosure and specification can, however, be embodied in many different forms and should not be construed as limited to the implementations set forth herein; rather, these implementations are provided so that this specification will be thorough and complete, and will fully convey the scope of the invention to those skilled in the art. Among other things, this specification can be embodied as methods or devices. Accordingly, any of the various implementations herein can take the form of an entirely hardware implementation or an implementation combining software and hardware aspects. The following specification is, therefore, not to be taken in a limiting sense.

Bioprocessing control systems include bioprocessing instruments connected and communicating directly with a bioprocess controller, which controls operation of the bioprocessing instruments. Conventional bioprocessing control systems have several drawbacks.

For example, conventional bioprocessing control systems have limited processing power and inefficiently consume power to control operation of the bioprocessing instruments. Conventional bioprocessing control systems also have limited ability to process and distinguish between different types of data, such as higher priority operational data and lower priority instrument data. In particular, conventional bioprocessing control systems generally inefficiently transmit the data along a single pathway to an operational control system without regard to the type of data and limit the manner of communication between bioprocessing instruments and the bioprocess controller, often requiring direct communication between the bioprocess controller and the bioprocessing instruments. In other words, conventional bioprocessing control systems are unable to distinguish between data sets transmitted from a variety of bioprocessing instruments, resulting in an exchange of all of the bioprocessing instrument's data mapped to the designated protocol addresses for one or more transactions involving the particular bioprocessing instrument. Due to the limited customization in data handling and/or processing, conventional bioprocess controllers generally inefficiently send, receive, and/or process all data from the bioprocessing instruments at the same time using a single pathway. Conventional bioprocessing control systems can also call, map and scatter indiscriminate data sets from one or more bioprocessing instruments across multiple levels and categories of communication protocol addresses, resulting in unnecessary processing and load on the bioprocessing control system.

Handling the data in such a manner can lead to operational deficiencies, as the quantity of data processed by the bioprocessing control systems increases rapidly in relation to the number of connected bioprocessing instruments that measure various parameters used for controlling the bioprocessing instruments. Single communication pathways and/or direct connections between the control system and instrument set can cause processing bottle necks as the number of connected instruments, the size of collected parameters and the digitalization of such parameters increases. As a result, conventional bioprocessing instruments are unable to efficiently process the increase in collected data without a large bandwidth allocation, leading to bandwidth issues and improperly controlled bioprocessing instruments. This can lead to significant delays in making necessary changes to the operation of the bioprocessing instruments or to improperly controlled bioprocessing instruments.

Conventional bioprocessing control systems also limit the number of devices physically connected to the bioprocess controller and each physical port of the bioprocess controller. These systems also specify and limit the number of protocol data addresses used to process and store data received from each bioprocessing instrument. For example, in any multi-device bioprocessing control system that communicates using a device-independent communication protocol, specific data from the various bioprocessing instruments can be mapped into the address space of the protocol. Otherwise, the bioprocessing control system will not be able to use the protocol to communicate with the devices in an effective manner. However, a given bioprocessing control system generally places constraints on how protocol addresses (e.g., Modbus addresses) are provisioned for the bioprocessing instruments. In the bioprocessing/bioproduction context, this can create processing inefficiencies and bottlenecks that unnecessarily constrain a bioprocessing control system's capacity and/or its speed at a given utilization level when many instruments are in direct communication with the main control system.

For example, the conventional bioprocessing control systems may designate a preset minimum or maximum number of protocol data addresses for each bioprocessing instrument that connects to it using a specific communication protocol. If each bioprocessing instrument in a many-instrument system communicates directly to such a bioprocessing control system, many more protocol addresses are utilized than is otherwise necessary. For example, the number of unique data elements corresponding to a particular instrument might be limited enough to only require mapping into a small number of protocol addresses (e.g., two, three, or four 16-bit protocol registers). However, bioprocessing control systems often automatically designate ten, or a minimum of ten, protocol addresses (e.g., ten 16-bit Modbus registers) for each instrument that connects to it. In such a situation, an excessive quantity of protocol addresses would be designated for many, or all, of the individual instruments connected to the system.

Such limitations significantly reduce the amount of data that can be processed by the bioprocessing control systems, the speed at which the bioprocessing control systems can process the data for making changes to the operation of the bioprocessing instruments, and the type of data that can be collected and processed. This can be especially problematic as the type of data that can be collected by bioprocessing control systems becomes more complex and diverse, because the conventional bioprocessing control systems would not be equipped to handle such data.

Further, conventional bioprocessing control systems can be expensive to operate because of the manner in which data is processed. For example, conventional bioprocessing control systems inefficiently transmit the data along a single pathway to an operational control system without regard to the type of data. Thus, conventional bioprocessing control systems generally implement one-to-one mapping for all types of data. The one-to-one mapping for all types of data coming from instruments can limit the number of instruments/devices connectable to the controller and/or, in certain circumstances, drastically increase the number of seats, licenses, security measures or other device allocation measures in the network.

The bioprocessing system consistent with implementations of the current subject matter employs an intelligent gateway that interfaces between a bioprocess controller and corresponding bioprocessing instruments to customize and optimize the efficient transmission, storage and processing of data received from bioprocessing instruments. For example, the gateway can receive and handle requests from the bioprocess controller for the data collected from the bioprocessing instruments. Consistent with implementations of the current subject matter, the data handled by the bioprocessing system can, via the gateway, customize handling the data. For example, the data can be prioritized based on a type of the data. In other words, some of the data can be designated as a primary data set and some of the data can be designated as a secondary data set that has a lower priority than the primary data set. Based at least on the priority of the data, the gateway can handle the data differently. For example, the gateway can send the primary data set to the bioprocess controller as a block of primary data. At the same or different time, the gateway can send the lower priority secondary data set to the bioprocess controller in portions.

Thus, the bioprocessing system described herein can reduce a computing load on the bioprocess controller and bioprocessing system and improve the computing efficiency of the bioprocess controller in processing the data and controlling the bioprocessing instruments. Such configurations can additionally and/or alternatively efficiently communicate with a larger and more diverse set of bioprocessing instruments and handle a larger and more diverse set of data. In other words, the bioprocessing system can enable identification, filtration, storage and transmission of a diverse set of data sets collected from bioprocessing instruments based on optimal use of the data sets in controlling and optimizing operation of bioprocessing instruments and biological processes. Additionally and/or alternatively, such configurations can efficiently process data that increases in size and quantity, as well as reduce or eliminate delays in making necessary changes to the operation of the bioprocessing instruments.

Additionally and/or alternatively, the bioprocessing system described herein can exchange a larger set of data sent from distinct bioprocessing instruments for a given set of protocol data addresses available to the system. The gateway can also be configurable to flexibly map instrument data from a plurality of bioprocessing instruments onto a given class and/or set of protocol data addresses used for exchanging data between those instruments and the main control system. Such systems can increase the amount of data and data sets that can be processed by the bioprocessing control systems, the speed at which the bioprocessing control systems can process the data for making changes to the operation of the bioprocessing instruments, and the type of data that can be collected and processed. Such configurations can additionally and/or alternatively increase the number of instruments connectable to the primary control system without an increase in the number of ports, seats, licenses, security measures or other device allocation measures in the network, thereby reducing the cost of operating the bioprocessing system.

Additionally and/or alternatively, the bioprocessing systems described herein can include a plurality of communication and data pathways from the bioprocess controller to a data lake and from the bioprocess controller to an automation control system. Different logic, communication schedules, transmissions frequencies and communication protocols can be implemented for sending bioprocessing data to the data lake compared to sending bioprocessing data to the automation control system, thereby improving the customizability and efficiency of the bioprocessing system.

Additionally and/or alternatively, the bioprocessing system described herein can handle various types of representations of data. For example, the gateway can receive a data set in a particular representation (e.g., unit of measurement). The gateway can convert the representation into another representation (e.g., another unit of measurement) that can be sent to and processed by the bioprocess controller.

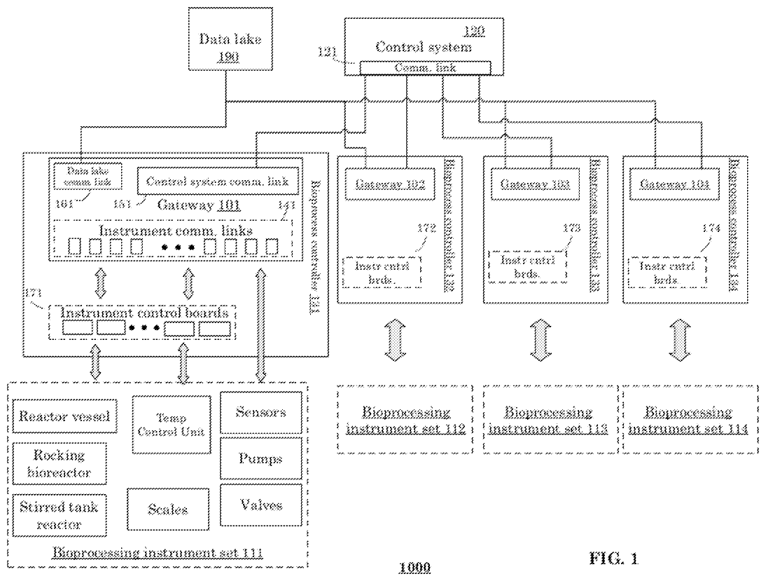

FIG. 1 is a block diagram of a bioprocessing system 1000, consistent with implementations of the current subject matter. The bioprocessing system 1000 can include a control system 120, a plurality of bioprocess controllers including bioprocess controllers 131, 132, 133, 134, a plurality of bioprocessing instrument sets including bioprocessing instrument sets 111, 112, 113, 114, and a data lake 190. The bioprocessing instrument sets can include a plurality of bioprocessing instruments. For example, the bioprocessing instrument sets can include at least a cell culture system including at least one sensor for monitoring cell cultures. The control system 120 can include a controller that includes at least one processor and at least one memory storing instructions, which when executed by the at least one processor are configured to perform one or more operations. For example, the controller of the control system 120 can control at least one bioprocessing instrument of a plurality of bioprocessing instruments of the bioprocessing instrument sets 111, 112, 113, 114. The at least one bioprocessing instrument can include one or more reactors, agitators, temperature control units, sensors, scales, motors, valves, pumps, rocking bioreactors, stirred tank reactors, mixers, chromatography systems, centrifugal separators, and/or other bioprocessing instruments. Many diverse instrument sets can be connected to the gateway to facilitate communication with the controller through the gateway and gateway logic. In one example, the instrument set includes a pump or set of pumps; sensors, such as rpm, pressure, flow, temperature, conductivity, pH, dissolved O₂, cell density, glucose and/or foam sensors; a controllable fluid manifold with fluid lines and valves; a stirred-tank bioreactor; a centrifugal separator; and/or a chromatography column used to process a cell culture containing one or more target biological components. In another example, the instrument set includes a pump or set of pumps; sensors, such as rpm, pressure, flow, temperature, conductivity, pH, dissolved O₂, cell density, glucose and/or foam sensors; a controllable fluid manifold with fluid lines and valves; a fermenter; a centrifugal separator; and/or a chromatography column used to process a cell culture containing one or more target biological components.

Each of the plurality of bioprocess controllers 131, 132, 133, 134 can include a corresponding gateway and instrument control board. For example, the bioprocess controller 131 includes a gateway 101 and an instrument control board 171, the bioprocess controller 132 includes a gateway 102 and an instrument control board 172, the bioprocess controller 133 includes a gateway 103 and an instrument control board 173, and the bioprocess controller 134 includes a gateway 104 and an instrument control board 174. The gateways 101, 102, 103, 104 can include at least one processor and at least one memory storing instructions configured to perform one or more operations as described herein. Although FIG. 1, shows bioprocess controllers 131, 132, 133, 134, gateways 101, 102, 103, 104, and instrument control boards 171, 172, 173, 174, any number of bioprocess controllers, gateways and instrument control boards can be included in the bioprocessing control system 1000.

The gateways 101, 102, 103, 104 communicate with the control system 120 through one or more control system communication links 151, 121. For example, the gateways 101, 102, 103, 104 can include the control system communication link 151 and the control system 120 can include the communication link 121. The control system communication links 151, 121 and/or the instrument communication link 141 can include any wired and/or wireless network including, for example, a wide area network (WAN), a local area network (LAN), a virtual local area network (VLAN), a public land mobile network (PLMN), the Internet, and/or the like.

The gateways 101, 102, 103, 104 can communicate with the instrument control boards 171, 172, 173, 174 and the bioprocessing instrument sets 111, 112, 113, 114 through an instrument communication link (e.g., an instrument communication link 141). The instrument control boards 171, 172, 173, 174 can communicate with bioprocessing instrument sets 111, 112, 113, 114 through similar communication links shown as arrows in FIG. 1. One or more bioprocessing instruments and instrument sets 111, 112, 113, and 114 can also communicate directly with gateways through instrument control links (e.g., instrument communication link 141).

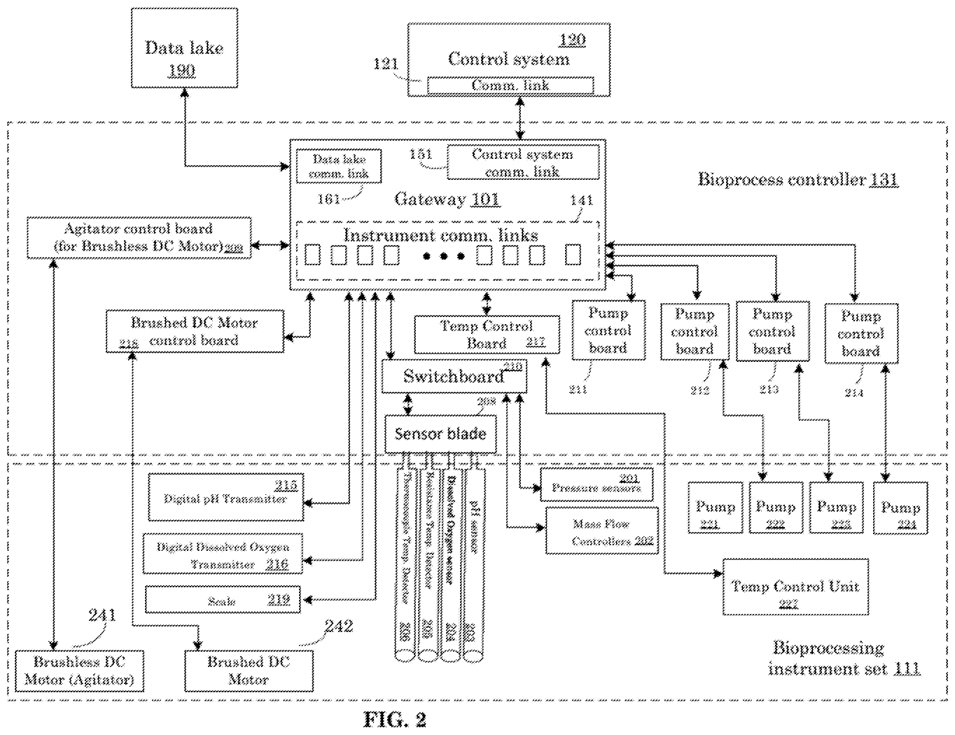

Through gateways 101, 102, 103, 104, the control system 120 exchanges data with the instrument control boards 171, 172, 173, 174, which in turn exchange data with the bioprocessing instruments sets 111, 112, 113, 114. The bioprocessing instruments sets 111, 112, 113, 114 can include one or more bioprocessing instruments. The one or more bioprocessing instruments include, but are not limited to, one or more agitators, temperature control units, sensors, scales, motors, valves, pumps, fermenters, rocking bioreactors, stirred tank reactors, mixers, chromatography systems, centrifugal separators, and/or other bioprocessing instruments. Additional bioprocessing instruments and configurations are illustrated in FIG. 2.

In some implementations, the gateways 101, 102, 103, 104 communicate with a data lake 190 through a data lake communication link (e.g., data lake communication link 161). For example, as shown in FIG. 1 each gateway 101, 102, 103, 104 communicatively connects the bioprocess controllers 131, 132, 133, 134 to the control system 120 through one or more communication links (e.g., control system communication link 151, communication link 121, etc.) and to data lake 190 through another communication link (e.g., data lake communication link 161). The data lake 190 can be a centralized repository designed to store, process, and secure large amounts of structured, semi-structured, and unstructured data. In other words, the data lake 190 can store and/or process the data received from the bioprocessing instruments.

In some implementations, all data from bioprocess controllers 131, 132, 133, 134 can first be sent from the gateways 101, 102, 103, 104 to the control system 120, which can then communicate data for analytics purposes to the data lake 190. Data can also be sent directly from bioprocess controllers 131, 132, 133, 134 to the data lake 190 for analytics. The data lake 190 can act as a data aggregator and/or a repository for data received from the gateways 101, 102, 103, 104, the control system 120 and/or other bioprocessing systems (not shown), and the data lake 190 can perform data aggregation, analytics and other data processing functions that can relieve load from the control system 120 and improve the efficiency and accuracy of process controls. For example, sending data directly from bioprocess controllers 131, 132, 133, 134 through the gateways 101, 102, 103, 104 and data lake communication links (e.g., data lake communication link 161) to the data lake 190 for analytics can reduce processing loads on the control system 120. The data lake 190 can also perform operations on data sent from bioprocessing instrument sets 111-114, such as converting units of measurement or converting data into a different format readable by the control system 120.

As described in more detail below, the data can include one or more data elements, such as “instrument data elements.” As used herein, an “instrument data element” (or “ide”) refers to a particular segment of data corresponding to a specific bioprocessing instrument or parameter of the bioprocessing instrument in the bioprocessing system 1000.

The data can be received by the gateways 101, 102, 103, 104 and sent to the data lake 190 and/or the control system 120 based on a type of the data, an intended use of the data, a priority level of the data and/or a frequency of data transmission for analytics processing and/or for controlling at least one of the bioprocessing instruments. This can help to increase efficiency of communicating the data and to reduce a load on the control system 120. In some implementations, the data is tagged with the intended use, the priority level, and/or the frequency of data transmission. The tag can be predetermined and/or automatically determined by the bioprocessing system 1000 (e.g., the gateways 101, 102, 103, 104 or another component). Based on the type of the data, the intended use of the data, the priority level of the data, and/or the frequency of data transmission, the data can be sent as a block and/or as a portion. Thus, it can appear that certain data is sent more quickly and/or frequently to the control system 120 relative to the data lake 190 or other components of the bioprocessing system 1000.

The data can include at least one primary data set, at least one secondary data set, at least one tertiary data set, and the like. The data can be tagged as being part of the at least one primary data set, the at least one secondary data set, the at least one tertiary data set, and the like. Depending on whether the data is tagged as being part of the at least one primary data set, the at least one secondary data set, the at least one tertiary data set, the data can have a different priority level, or the like. For example, the at least one primary data set has a higher priority than the at least one secondary data set, the at least one secondary data set has a higher priority than the at least one tertiary data set, and so on. In other words, the at least one secondary data set has a lower priority than the at least one primary data set, the at least one tertiary data set has a lower priority than the at least one secondary data set, and so on. In one example, the primary data set includes sensor data (e.g., rpm data from an accelerometer), or sensor data from a pressure, flow, temperature, conductivity, pH, dissolved O₂, cell density, glucose and/or foam sensor. In this example, the secondary data set is the type of sensor, and the tertiary data set is a name, code-name, serial number, color or distinguishing physical feature associated with the sensor. In another example, the primary data set can include, but is not limited to sensor data; rpm data from an agitator or impeller; temperature data from a thermocouple; mass data from a scale; rpm data from a motor shaft; configuration data (open/closed) from a valve; power data from a pump; pH data of a biological culture within a fermenter, conductivity data from a biological culture within a bioreactor; glucose concentration data from a biological culture within a bioreactor; rpm or power data from a mixer, liquid flow rate data from a column of a chromatography system, rpm data of a centrifugal separator; and/or product composition data from the outlet of a fermenter, bioreactor, mixer, centrifugal separator or column of a chromatography system. The secondary data set can include, but is not limited to sensor type, agitator type, fermenter volume or dimensions, bioreactor volume or dimensions, mixer type, bioreactor type, fermenter type, volume or dimensions of a centrifugal separator, and/or dimensions or number of columns of a chromatography system. Tertiary data can include, but is not limited to name, code-name, serial number, color or distinguishing physical feature of an agitator, mixer, ferment, bioreactor, centrifugal separator and/or chromatography system. In these examples, the primary data set fluctuates and varies dynamically throughout the course of the biological process and is vital for assessing process parameters and controlling the biological process with the control system 120. In these examples, the secondary data set is constant and necessary for assessing process parameters and controlling the biological process with the control system 120. In these examples, the tertiary data set is constant and identifying data for the instrument. The data is processed, stored and transmitted by the gateways 101, 102, 103, 104 based on priority prior to the data reaching the control system 120.

The primary data set, as described in more detail below, can include a block of primary data, which can be measured by the plurality of bioprocessing instruments of the bioprocessing system 1000. The primary data set can include primary data such as a plurality of parameters measured by the plurality of bioprocessing instruments that impact operation of at least one of the bioprocessing instruments. In other words, the primary data set includes operational data used for detecting and implementing process parameters that control operation of the plurality of bioprocessing instruments (e.g., of the bioprocessing instrument sets 111, 112, 113, 114). The primary data set can include primary data that is likely to change. The primary data set can include data such as a pump power, a motor speed, rotations per minute of an impeller, sensor data, pressure readings, flow rate readings, pH readings, temperature readings, proximity sensor readings, valve positions and configurations, dissolved oxygen readings, carbon dioxide readings, foam sensor readings, cell density readings, a weight, other process and bioreactor parameters, and/or the like.

The primary data set can be measured by the plurality of bioprocessing instruments and used by the control system to control operation of the bioprocessing instruments. The primary data set can additionally and/or alternatively include data that is likely to quickly change. Thus, the primary data set can be tagged with a higher priority level than the secondary data set and/or the tertiary data set. At least because the primary data set has a higher priority level than the secondary data set and/or the tertiary data set, the primary data set can be exchanged between the gateway 101 and the control system 120 as a block of primary data. This allows for all of the primary data to be exchanged since the time primary data was previously retrieved from the plurality of bioprocessing instruments and/or exchanged between the gateway 101 and the control system 120.

The secondary data set can include secondary data, such as instrument data associated with the plurality of bioprocessing instruments. In some implementations, the secondary data set does not impact operation of the plurality of bioprocessing instruments. The secondary data set can include secondary data, such as instrument information about at least one of the plurality of bioprocessing instruments. The secondary data set can be unlikely to change during operation of the plurality of bioprocessing instruments. The secondary data set can include device identification data or device state data. Device identification data can include, but is not limited to, information identifying manufacturer of equipment, manufacture date, model, serial number, device color, version of a device or other information identifying the device. Device state data can include, but is not limited to, device setup data, device configuration data, device calibration data, data indicating whether the device is powered on or off, data indicating whether the device is online and connected to a communication network or offline and disconnected from a communication network and/or other device state data.

Because the secondary data set can include instrument data that does not impact operation of the plurality of bioprocessing instruments, the secondary data set can be tagged with a lower priority than the primary data set. In some implementations, due to the lower priority level of the secondary data set, the secondary data set can be exchanged between the plurality of bioprocessing instruments, the gateways 101, 102, 103, 104, the control system 120, the data lake 190, or the like, less frequently, in smaller portions, or the like than the primary data set.

This data set can also be categorized as tertiary data as described above depending on configurations and customizations set by the operator or end-user. For example in some implementations, the secondary data set can be further tagged and categorized into a tertiary data set and/or a quaternary data set based on data type, intended use, priority, transmission frequency, and/or timing rules governing the exchange of process control data between the bioprocessing instrument sets 111, 112, 113, 114, the gateways 101, 102, 103, 104, the control system 120, and/or the data lake 190. The tertiary data set and/or the quaternary data set can be exchanged less frequently and/or in smaller portions than the secondary data set and primary data set.

While the primary data set is described herein as impacting operation of at least one of the plurality of bioprocessing instruments, in some implementations, certain secondary data sets can also be used as the primary data set including operational data processed by the control system 120 to send a control signal to at least one of the plurality of bioprocessing instruments or to cause and direct an instrument response to a specific piece of equipment. As an example, device color can be both part of the secondary data set for identifying the bioprocessing instrument and the primary data set that impacts operation of the bioprocessing instrument. For example, the device color can be processed by the control system 120 to then apply power to a corresponding color LED light on the control system 120 display, interface or hardware at the gateway 101, 102, 103, 104 display, interface or hardware. Likewise, a device power state can be part of both the secondary data set and the primary data set, because it can be used as a status indicator and by the control system 120 to apply power to the particular bioprocessing instrument.

FIG. 2 is a block diagram of the bioprocessing system 1000 consistent with implementations of the current subject matter that further illustrate details of the bioprocess controller 131 and bioprocessing instrument set 111 of FIG. 1. While the bioprocess controller 131 and the corresponding gateway 101 are shown and described in greater detail herein, the bioprocess controllers 132, 133, 134 and the corresponding gateways 102, 103, 104 can have the same and/or similar features as the bioprocess controller 131 and corresponding gateway 101. Each bioprocess controller, and its corresponding gateway, can have similar elements and connections to those shown for bioprocess controller 131 and gateway 101. In other implementations, the elements of each bioprocess controller and corresponding instrument sets might vary.

Referring to FIG. 2, the bioprocess controller 131 can further include a plurality of control boards, such as pump control boards 211, 212, 213, 214, a temperature control board 217, an agitator control board 209, a brushed DC motor control board 218, a temperature control board 217, a sensor blade 208, and switchboard 210. The bioprocessing instrument set 111 can include a plurality of bioprocessing instruments. The plurality of bioprocessing instruments can include at least one pump, such as pumps 221, 222, 223, 224, a temperature control unit 227, pressure sensors 201, mass flow controllers 202, digital pH transmitter 215, digital dissolved oxygen transmitter 216, scale 219, brushless DC motor 241, brushed DC motor 242, pH sensor 203, dissolved oxygen sensor 204, resistance temperature detector 205, and thermocouple temperature detector 206 (which connect to sensor blade 208 as shown). The switchboard 210 can act as a communications multiplexer. In an exemplary implementation, the switchboard 210 is a network switch, such as an Ethernet switch that can route and load balance data transmission from the bioprocessing instruments of the bioprocessing instrument set 111 to the gateway 101 and bioprocess controller 131.

Again referring to FIG. 2, the pressure sensors 201, the mass flow controllers 202, and the sensor blade 208 connect through switchboard 210 to gateway 101. The pumps 221, 222, 223, 224 connect to the pump control boards 211, 212, 213, 214 as shown, which in turn connect to the gateway 101 through the instrument communication links 141. The temperature control unit 227 connects to the temperature control board 217, which in turn connects to the gateway 101 through the instrument communication links 141. In other implementations, the temperature control unit 227 can use Ethernet protocol to communicate temperature data through the switchboard 210 to the temperature control board 217 or directly to the gateway 101. The brushless DC motor 241 (used to agitate reaction containers) connects to the agitator control board 209, which in turn connects to the gateway 101 through the instrument communication links 141. The brushed DC motor 242 connects to the brushed DC motor control board 218 which in turn connects to the gateway 101 through instrument the communication link 141. The digital pH transmitter 215, the digital dissolved oxygen transmitter 216, and the scale 219 connect to the gateway 101 directly through instrument communication links 141. In exemplary implementations, the scale 219 is a Wheatstone bridge device that connects directly to the gateway 101 or an Ethernet-based device that can communicate weight data to the gateway 101 through the switchboard 210.

The illustrated implementation shows just one example. Alternative implementations vary the components and connection paths shown without necessarily departing from the spirit and scope of the present disclosure. For example, some elements shown housed within the bioprocess controller 131 might, in alternative implementations, be external to a bioprocess controller, such as the bioprocess controller 131. Conversely, some instruments shown as part of the external instrument set 111 might, in alternative implementations, be incorporated into a bioprocess controller, such as the bioprocess controller 131.

As shown, the gateway 101 and the control system 120 communicate through a connection between the communication link 151 at the gateway 101 and the communication link 121 at the control system 120.

At the application-layer level (and/or other layers) of the Open Systems Interconnect (“OSI”) model, the control system 120 and the gateway 101 communicate using a protocol suited for automated systems. A commonly used protocol is Modbus. Modbus has evolved into different protocol “suites” that package Modbus's application-layer rules together with protocols in other OSI layers for different implementations. For example, “Modbus RTU” can be adapted to work over serial connections such as RS-232 or RS-485. As another example, “Modbus TCP/IP” works over Ethernet connections.

The underlying principles of the bioprocessing system 1000 are generally independent of any specific protocol and or physical connection type. Implementations of the current subject matter can be applied to and implement any communication protocol used in a bioprocessing system where the protocol designates a set of data addresses (or the equivalent thereof) for identifying data (e.g., the primary data set, the secondary data set, etc.) exchanged using the protocol. Therefore, for ease of explanation, reference will be made herein to a “communication protocol address.” The illustrated examples will be explained with some terminology corresponding to the Modbus protocol. However, the principles of the current subject matter apply to many alternative implementations using other communication protocols in which data address are defined and used for communications between devices and systems.

The Modbus data model provides for data that is addressable in single-bit size and data that is addressable in 16-bit size. Modbus uses the label “Holding Register” to designate a data address of a 16-bit word that can be either write data or read data. For convenience of the example illustrated herein, protocol addresses “R1-R300” are referenced. This does not follow the full numbering format of Modbus Holding Registers. However, for ease of reference in the context of the particular example illustrated herein, “R1-R300” refers to 300 different data addresses (i.e., R1, R2, R3 . . . . R300) corresponding to Modbus “registers,” each register addressing a 16-bit word of data.

In the examples illustrated herein, each instrument data element is assigned a data address within the relevant communication protocol (e.g., Modbus) used to exchange data between instruments on the one hand and the control system on the other hand. In one example, for a given protocol address (e.g., “R1,” “R2”, etc.), one instrument data element is transmitted from the bioprocess controller to the control system. If each data address is used to address a 16-bit data element, then each instrument data element is transmitted/received as a 16-bit word.

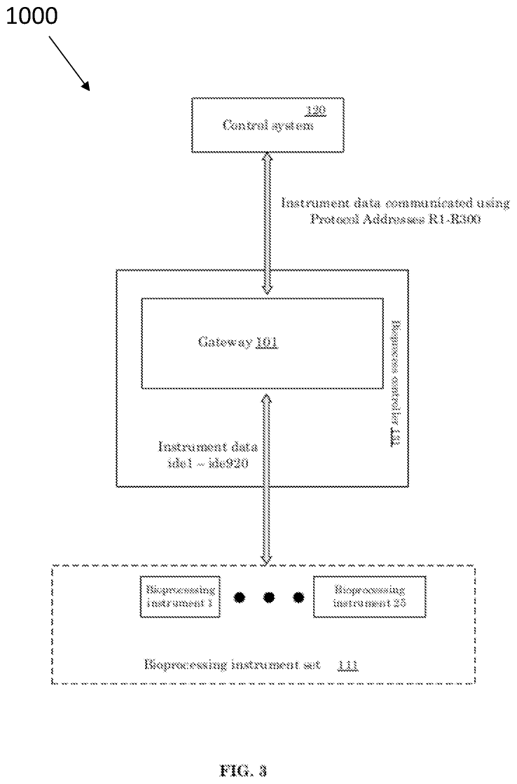

FIG. 3 is a block diagram of a bioprocessing system consistent with implementations of the current subject matter. As shown in FIG. 3, the bioprocessing system 1000 includes the control system 120, the gateway 101, and the bioprocessing instrument set 111. The gateway 101 exchanges data between the bioprocess controller 131 and the plurality of bioprocessing instruments of the bioprocessing instrument set 111. The gateway 101 also exchanges data between the bioprocess controller 131 and the control system 120. In this example, bioprocessing instrument set 111 includes 25 bioprocessing instruments (e.g., bioprocessing instrument 1-bioprocessing instrument 25), although other quantities are contemplated. The bioprocessing instruments correspond to 920 unique data elements. Each of the unique data elements can include up to a 16-bit addressable word of data. The gateway 101 and the control system 120 communicate using the Modbus protocol (or other protocol) and a total of 300 Modbus “registers” (protocol data addresses), each addressing one 16-bit word of data. The gateway 101 enables using a smaller number of Modbus addresses than would ordinarily be used to exchange a given number of unique instrument data elements. In the present example, 920 instrument data elements are communicated using only 300 Modbus communication protocol addresses provisioned for communication between the gateway device 101 and the control system 120. As will be clear to one skilled in the art, the techniques presented herein are not limited to the specific example presented. For example, in alternatives, more or fewer instrument data elements could be flexibly mapped into a given number of protocol data addresses of a communication protocol.

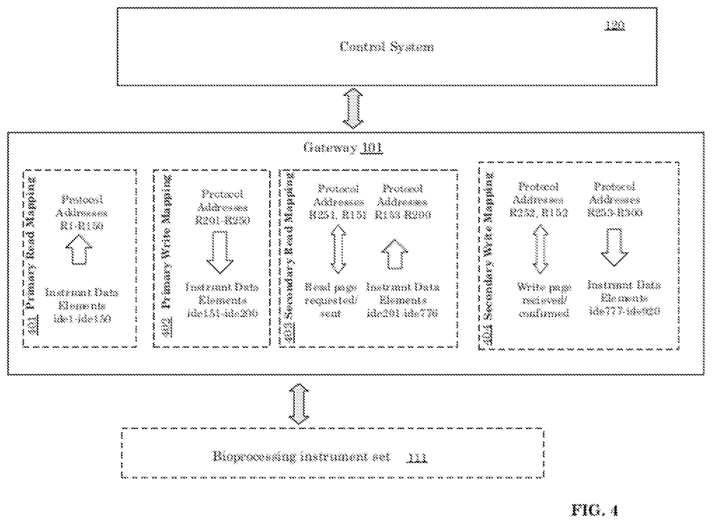

With reference to FIGS. 4-10 below, the illustrated implementations operate by selectively swapping out different sets of secondary data for mapping onto a given set of protocol data addresses used to communicate between the gateway 101 and the control system 120.

FIG. 4 is a block diagram of data mappings between the data associated with the plurality of bioprocessing instruments (e.g., including the instrument data elements) and communication protocol addresses, consistent with implementations of the current subject matter. The various data mappings can be implemented by the gateway 101 and the controller of the control system 120. Specifically, the gateway 101 helps implement a primary read data mapping 401, a primary write data mapping 402, a secondary read data mapping 403, and a secondary write data mapping 404. As used herein, “read data” refers to data from the plurality of bioprocessing instruments that is requested by the control system 120 and sent to the control system 120 by the gateway 101. Further, as used herein, “write data” refers to data sent from the control system 120 to the gateway 101 for writing to at least one of the bioprocessing instruments connected to the bioprocess controller 131 (or to their corresponding control boards, some of which, in the context of the implementations illustrated herein, are housed within the bioprocess controller 131). For example, the write data can be used to control operation of at least one of the bioprocessing instruments.

The primary read mapping 401 and the primary write mapping 402 each use a “one-to-one” mapping of communication protocol addresses to instrument data elements. For example, the block of primary data of the primary data set can include a first parameter measured by at least one of the plurality of bioprocessing instruments, a second parameter measured by at least one (e.g., the same or another one) of the plurality of bioprocessing instruments, and so on. In this example, the first parameter can be mapped to a first communication protocol address and the second parameter can be mapped to a second communication protocol address. In some implementations, primary data from each of the plurality of bioprocessing instruments is mapped a unique communication protocol address. For example, the primary read mapping 401 can map 150 different instrument data elements (ide1-ide150) (e.g., parameters measured by the plurality of bioprocessing instruments) to 150 different communication protocol addresses (R1-R150). The primary write mapping 402 can map 50 different instrument data elements (ide151-ide200) (e.g., parameters measured by the plurality of bioprocessing instruments) to 50 different communication protocol data addresses (R201-R250). While other quantities are contemplated, the quantity of the primary data in the primary data set (e.g., the quantity of bioprocessing instruments, parameters measured by the plurality of bioprocessing instruments, and/or the like) can be the same as the quantity of communication protocol addresses.

The secondary read mapping 403 and the secondary write mapping 404 each use a many-to-one mapping of instrument data elements (e.g., the secondary data set) to communication protocol data addresses. For example, a portion of the secondary data set can include secondary data corresponding to at least two of the plurality of bioprocessing instruments. The portion of the secondary data set can be mapped to a single communication protocol address.

In some implementations, the secondary data set is stored across a plurality of pages. For example, the secondary read mapping 403 and the secondary write mapping 404 assign an identifier, such as a page number of a plurality of pages to a portion of the secondary data set, such as different data elements (e.g., the secondary data set) that share the same communication protocol address. The portion of the secondary data set can include secondary data from a plurality of bioprocessing instruments. The term “page” as used herein is an identifier used to identify the page of the plurality of pages. For example, the identifier can be used externally to the communication protocol (e.g., Modbus or other relevant communication protocol), such as in locations in an expanded data address space that allows a many-to-one mapping between instrument data elements and communication protocol addresses defined within the relevant communication protocol (e.g., Modbus or other relevant communication protocol). Accordingly, the secondary data set can include a plurality of portions that are exchanged between the gateway 101 and the control system 120. Each of the portions can include secondary data from a plurality of bioprocessing instruments (e.g., at least two bioprocessing instruments) and can be mapped to a single communication protocol address.

As an example, the secondary read mapping 403 can use twelve different page numbers (e.g., identifiers) to map twelve pages of secondary data across a given set of read communication protocol addresses. A page number corresponding to requested read data (e.g., instrument data that the control system 120 requests be sent to it from gateway 101) is sent from the control system 120 to the gateway 101 using communication protocol address R251. When the gateway 101 replies by sending the requested secondary data set to control system 120, the gateway 101 uses communication protocol address R151 to send the page number (e.g., identifier) corresponding that data.

In this example, communication protocol addresses R153-R200 can be used to send the requested data from the gateway 101 to the control system 120. Therefore, for each page number of data requested and sent, the gateway 101 can include 48 different data elements using the 48 communication protocol addresses R153-R200. Therefore, in this example, the mapping 403 enables 576 instrument data elements (ide201-ide776) to be sent using 48 communication protocol addresses by identifying and sending data corresponding to different defined pages for those protocol addresses. Of course, the use of twelve pages of data is only one example. More or fewer pages can be defined depending on how many unique secondary instrument read data elements correspond to a given bioprocessing instrument set in a given bioproduction or bioprocessing system.

In similar fashion, the secondary write mapping 404 uses three different page numbers to map three pages of secondary write data across a given set of communication protocol addresses. Page numbers (e.g., identifiers) corresponding to the secondary write data (e.g., instrument data that the control system 120 requests be written to instruments connected to the bioprocess controller 131) are sent from the control system 120 to the gateway 101 using communication protocol address R252. The gateway 101 replies by sending the page number of the write data back to the control system 120 using the protocol data address R152 to confirm the page number (e.g., identifier) of write data received.

In this example, the protocol data addresses R253-R300 are used to send instrument secondary write data from the control system 120 to the gateway 101. For each page number of the secondary write data sent, 48 different instrument data elements can be included using the 48 communication protocol addresses R253-R300. Therefore, in this example (with three pages), the mapping 404 enables 144 instrument secondary write data elements (ide777-ide920) to be sent from the control system 120 to the gateway 101 using 48 data addresses by identifying and sending data corresponding to different defined pages for those protocol addresses. Of course, the use of three pages of data is only one example. More or fewer pages can be defined depending on how many unique secondary instrument write data elements correspond to a given bioprocessing instrument set in a given bioproduction or bioprocessing system.

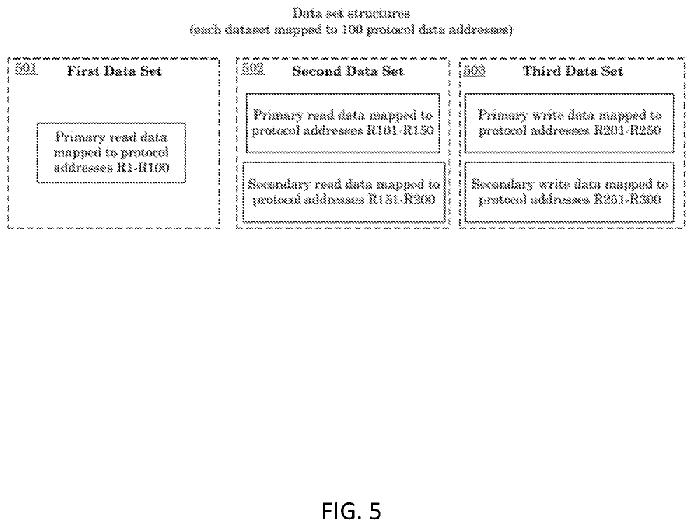

FIG. 5 illustrates data set structures in accordance with implementations of the current subject matter that use protocol data set structures for exchanging data between the control system 120 and the gateway 101. This example includes a first data set 501, a second data set 502, and a third data set 503, each corresponding to 100 protocol (e.g., Modbus) registers (data addresses), though other quantities are contemplated. Each data set includes either read data or write data. In this example, the first data set 501 includes primary read data mapped to communication protocol addresses R1-R100. The second data set 502 includes primary read data mapped to communication protocol addresses R101-150 and the secondary read data mapped to communication protocol addresses R151-R200. The third data set 503 includes primary write data mapped to communication protocol address R201-R250 and the secondary write data mapped to communication protocol addresses R251-R300. Data can be written and read using the gateway 101 as described herein.

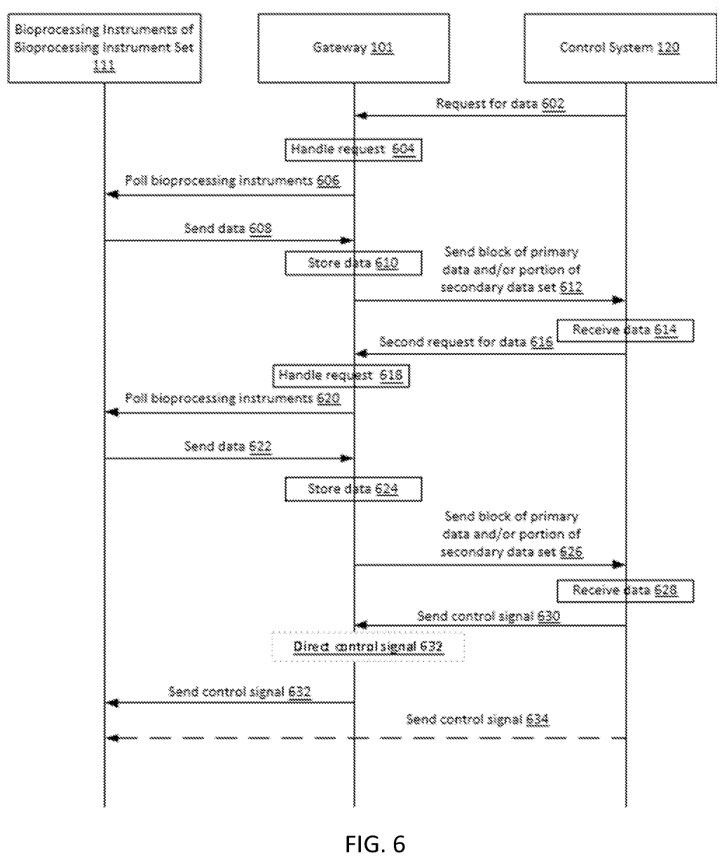

FIG. 6 is a swim-lane diagram showing an example process 600 of processing data from a plurality of bioprocessing instruments and controlling at least one bioprocessing instrument using the data, consistent with implementations of the current subject matter. As shown in FIG. 6, the plurality of bioprocessing instruments of the bioprocessing instrument set 111, the gateway 101 of the bioprocess controller 131, and the control system 120 (including a controller) can exchange data in a manner that reduces a processing load on the controller of the control system 120, the bioprocess controller 131, improves the efficiency of processing the data and controlling the at least one bioprocessing instrument, and/or the like.

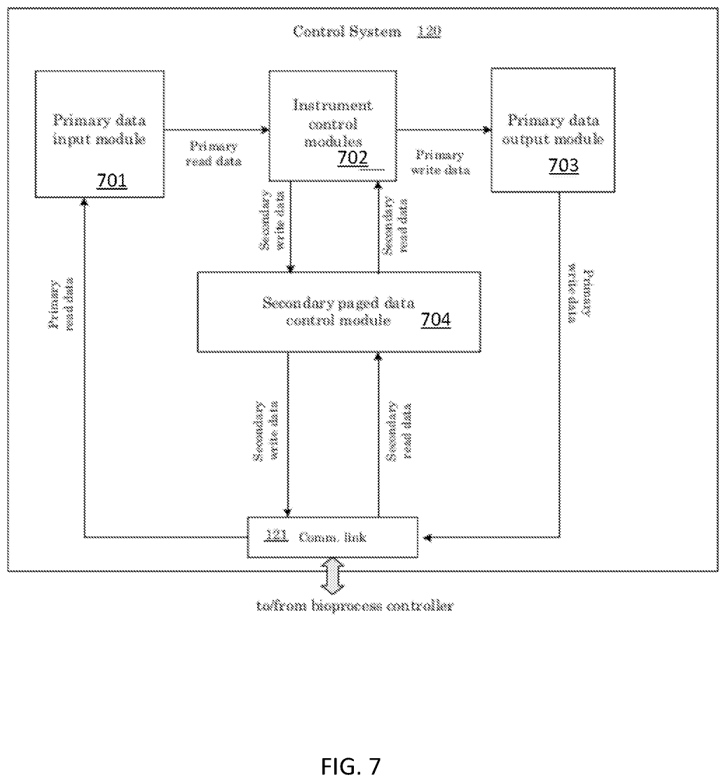

FIG. 7 is a block diagram of the architecture of the control system 120 consistent with implementations of the current subject matter. As shown in FIG. 7, the control system 120 includes the communication link 121, a primary data input module 701, a plurality of instrument control modules 702, a primary data output module 703, and a secondary paged data control module 704. The primary data input module 701, the plurality of instrument control modules 702, the primary data output module 703, and/or the secondary paged data control module 704 can include a dedicated processor and/or memory for storing instructions for execution by the processor, can form a portion of the control system 120, and/or can be operated by the controller of the control system 120. Note that, in different implementations, a communication link such as the communication link 121 can include different types of communication links. For example, in one example, the communication link 121 includes a serial card adapted to work in conjunction with a Modbus RTU implementation. In another example, the communication link 121 includes an Ethernet port adapted to work with a Modbus TCP/IP implementation. These are just examples and not to be considered limiting the scope of this detailed description or exemplary implementations. Also note, as will be understood by one skilled in the art, the various illustrated modules in fact are implemented by a processor (e.g., the controller) of control system 120 operating in conjunction with a working memory of control system 120. These processor and memory elements are not shown in FIG. 7 for ease of illustration.

Referring back to FIG. 6, at 602, the controller at the control system 120 can send a request to the gateway 101 for data associated with the plurality of bioprocessing instruments of the bioprocessing instrument set 111. The request can be sent from the control system 120 to the gateway 101 via the communication link 121.

The data requested by the control system 120 can include a primary data set and/or a secondary data set, consistent with implementations of the current subject matter. Consistent with implementations of the current subject matter, the primary data set includes a block of primary data measured by the plurality of bioprocessing instruments. As described herein, the primary data set (e.g., the block of primary data) includes operational data associated with the plurality of bioprocessing instruments. The operational data can include at least one parameter (e.g., a first parameter, a second parameter, a third parameter, and so on) measured by the plurality of bioprocessing instruments that impacts operation of at least one of the plurality of bioprocessing instruments. Consistent with implementations of the current subject matter, the secondary data set has a lower priority (which can be predetermined and/or tagged with the secondary data set) than the primary data set. As described herein, the secondary data set can be stored across a plurality of pages. For example, an identifier, such as a page or page number can be associated with a portion of the secondary data set. The secondary data set includes instrument data associated with the plurality of bioprocessing instruments. The instrument data can include instrument information about at least one of the plurality of bioprocessing instruments.

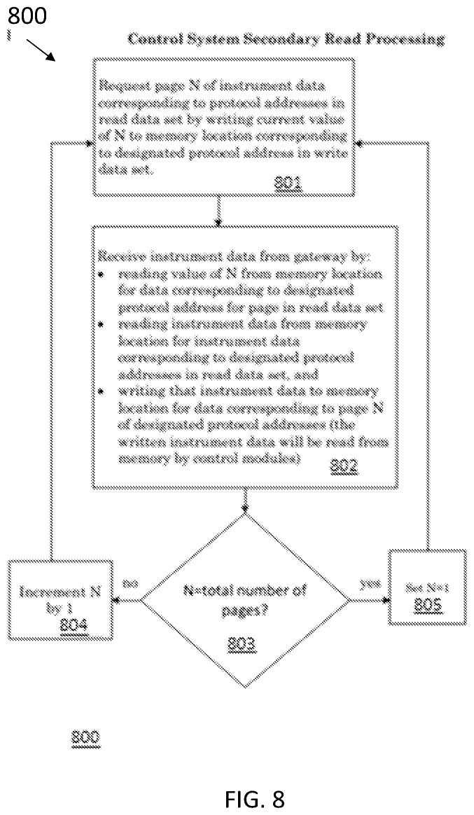

Referring to FIG. 8, which illustrates a process 800 implemented by the control system 120 for processing secondary read data, consistent with implementations of the current subject matter, at step 801, the control system 120 can include, in the request, the identifier of the portion of the secondary data set. For example, the identifier included in the request can include page N (e.g., page 1, 2, 3, etc.) assigned to the portion of the secondary data set and corresponding to a designated communication protocol addresses corresponding to the secondary read data set (e.g., corresponding to protocol registers R153-200). In some implementations, the control system 120 (e.g., via the controller of the control system 120) makes the request by sending the request page number using protocol address R251. Because the request involves sending data (e.g., a requested page number N) from the control system 120 to the gateway 101, in this example, a protocol address in a “write” data set (e.g., the third data set 503 illustrated in FIG. 5) can be used for making the request. The architecture of the control system 120 corresponding to the write data set is described in more detail below with respect to at least step 614.

At 604, the gateway 101 can receive and/or handle the request from the controller of the control system 120. The gateway 101 can retrieve the requested data from the plurality of bioprocessing instruments. To retrieve the requested data, the gateway 101 can poll the plurality of bioprocessing instruments to request the data. The gateway 101 can poll, at 606, the plurality of bioprocessing instruments at regular and/or predetermined intervals (e.g., every 5 seconds, 10 seconds, 30 seconds, minute, 10 minutes, 30 minutes, hour, and/or the like). The gateway 101 can then store the data in memory of the gateway 101 until the gateway 101 receives the request at 604. Additionally and/or alternatively, the gateway 101 can poll, at 606, the plurality of bioprocessing instruments for the data in response to receiving the request at 604.

At 608, the plurality of bioprocessing instruments sends the data to the gateway 101 in response to the poll at 606. In some implementations, both primary data and secondary data is sent from the bioprocessing instruments to the gateway 101 in response to each poll. In other implementations, only primary data is sent from the bioprocessing instruments to the gateway 101, such as when there have been no updates to the secondary data from the previous poll.

At 610, the gateway 101 stores the data received from the plurality of bioprocessing instruments in the memory of the gateway 610. The gateway 101 can store the primary data set in a primary data register. When storing the primary data set, the gateway 101 can map a unique communication protocol address to each parameter measured by the plurality of bioprocessing instruments and/or to each bioprocessing instrument of the plurality of bioprocessing instruments. This allows for one-to-one mapping of the primary data set, as described herein.

The gateway 101 can additionally and/or alternatively store the secondary data set in a secondary data register. When storing the secondary data set, the gateway 101 can map a single communication protocol address to a portion of the secondary data set that corresponds to at least two of the bioprocessing instruments of the plurality of bioprocessing instruments. This allows for one to many mapping of the secondary data set, as described herein. The gateway 101 can assign an identifier (e.g., a page number N of a plurality of pages) to a corresponding portion of the secondary data.

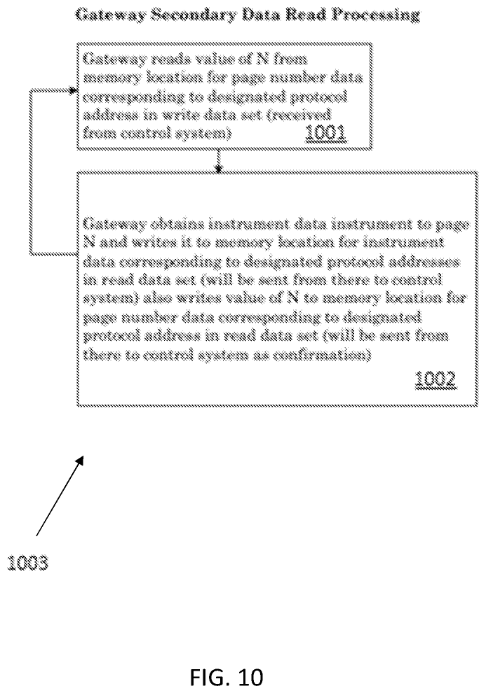

FIG. 10 illustrates a process 1003 implemented by the gateway 101 for processing the request for data including a secondary data set, such as secondary read data, consistent with implementations of the current subject matter. At step 1001, the gateway 101 reads the value of an identifier included in the request. Here, the identifier can include a page number N corresponding to a particular page of the plurality of pages assigned to the secondary data set. In some implementations, the gateway 101 reads the value of N from the memory of the gateway 101 for page number data corresponding to the designated communication protocol address. As described in more detail below with respect to at least step 614, the gateway 101 can receive the particular page number as part of the request from the control system 120 using the communication protocol address (e.g., R251) designated for page numbers of requested secondary read data (e.g., the secondary data set). At 1002, the gateway 101 obtains (e.g., at 606) the secondary data set from the plurality of bioprocessing instruments and writes the portion of the secondary data set corresponding to page N to the memory array for secondary read data of the gateway 101 to be sent to the control system 120 using the relevant designated communication protocol addresses (e.g., R153-R200). The gateway 101 can also write the value of N to the same data set for sending to the control system 120 using the relevant communication protocol address for secondary read page number (e.g., R151). As the gateway 101 continues to receive requests for data including the secondary data set, the process 1003 returns to 1001.

Again referring to FIG. 6, in some implementations, the gateway 101 receives the primary data set and/or the secondary data set from the plurality of bioprocessing instruments in a first unit of measurement and converts the first unit of measurement to a second unit of measurement prior to sending the block of primary data or the secondary data set to the controller of the control system 120. This helps to standardize the data and reduce processing loads on the controller of the control system 120.

At 612, the gateway 101 sends, in response to the request, the requested data to the controller of the control system 120. The gateway 101 sends the primary data set as a block of primary data, as described herein. The block of primary data includes the primary data collected from and/or measured by the plurality of bioprocessing instruments since a previous request was received and handled by the gateway 101. The primary data set is sent as a block of primary data to the control system 120 due at least in part to the high priority level of the primary data set. The gateway 101 can cause the controller of the control system 120 to control at least one bioprocessing instrument of the plurality of bioprocessing instruments by sending the block of primary data to the control system 120. For example, as described herein, the control system 120 can use the block of primary data to adjust one or more operations and/or control at least one of the bioprocessing instruments.

At 612, the gateway 101 further sends the requested portion of the secondary data set to the control system 120. In other words, the gateway 101 sends the requested portion of the secondary data set to which the page number N included in the request is assigned. This helps to reduce the load on the controller of the control system 120 and/or the bioprocess controller 131 as less data is sent from the gateway to the control system 120 and less data is processed by the control system 120 at the same time as the control system 120 is processing the higher priority block of primary data. This can additionally and/or alternatively reduce the computer power needed to process the request because fewer communication protocol addresses are needed to exchange the secondary data set. The portion of the secondary data set can be sent from the gateway 101 to the control system 120 during the sending of the block of primary data from the gateway 101 to the control system 120.

At 614, the control system 120 receives the data from the gateway 101 in response to the request. For example, the control system 120 can receive the block of primary data. The control system 120 can additionally and/or alternatively receive the portion of the secondary data set, thereby reducing a processing load on the controller of the control system 120. The control system 120 can receive the portion of the secondary data set during the receiving of the block of primary data.

Referring back to FIG. 7, the communication link 121 of the control system 120 receives the data from the gateway 101 of the bioprocess controller 131 (see FIGS. 1 and 2). Primary read data including the received block of primary data received by the communication link 121 can be handled by the primary data input module 701. The primary data input module 701 receives the primary read data (e.g., the block of primary data) and, based on the protocol addresses used to send particular instrument primary read data elements (e.g., the block of primary data), uses the working memory of the control system 120 to provide the data to the relevant instrument control module of the instrument control modules 702 of the control system 120.

As an example, a primary data received a particular sensor can be, based on the relevant mapping between that sensor read data and the communication protocol address used to send the data to the control system 120, stored by the primary data input module 701 in a relevant memory array designated for that the sensor read data. The sensor read data is then read by the relevant control module of instrument control modules 702 corresponding to that sensor. When the instrument control modules 702 writes primary data to the bioprocess controller 131, the instrument control modules 702 writes the primary data to a relevant memory array for data mapped to the corresponding protocol (e.g., Modbus or other protocol) registers and the primary data output module 703 sends the data to the bioprocess controller 131 via the communication link 121 using those registers. In this example, all primary data elements (e.g., the primary data) are mapped on a one-to-one basis to communication protocol data addresses and, therefore, page numbers may not be used, as described herein.

By contrast, secondary data sets are mapped using identifiers (e.g., page numbers) in addition to communication protocol addresses and can be handled by the secondary paged data control module 704. When secondary read data of the portion of the secondary data set is received through the communication link 121, the secondary paged data control module 704 uses the received page number and the relevant protocol addresses to write the secondary data set to an appropriate array in working memory of the control system 120 accessed by the relevant one or more control modules of instrument control modules 702. Similarly, when secondary write data is sent by one or more of the control modules 702 from the control system 120 to the bioprocess controller 131 (e.g., for writing to a corresponding instrument or instrument control board), the secondary paged data control module 604 uses the relevant page number to send the instrument data elements corresponding to that page number and the relevant protocol registers using the relevant protocol registers for transmission in accordance with the communication protocol.

Referring again to FIG. 8, at step 802, the control system 120 receives the requested instrument data by reading the page number received by control system 120 in the current incoming secondary read data set (e.g., the secondary data set), such as by using the communication protocol address R151 in second data set 502 illustrated in FIG. 5. The control system 120 can use the assigned page number N to identify which portion of the secondary data set is part of the current incoming secondary read data received using the protocol addresses 153-200 in the second data set 502 illustrated in FIG. 5 and writing the read data to one or more memory arrays of the control system 120 reserved for the corresponding instrument data elements. For example, the secondary paged data control module 704 can read the value of N from the memory location for data corresponding to the designated communication protocol address for the pages of the read data set. The secondary paged data control module 704 can read the portion of the secondary data set from memory corresponding to the designated protocol address in the read data set. The secondary paged data control module 704 can then write the portion of the secondary data set to memory of the control system corresponding to the page N.

At 803, the control system 120 (e.g., via the controller of the control system 120) determines whether the value of N corresponding to the portion of the secondary data set received by the control system 120 is equal to a maximum value of N, i.e., a value corresponding to the total number of pages designated for secondary read data of the secondary data set. If the value of N does not correspond to the maximum value of N, at 804, the value of Nis incremented by 1 and the flow returns to 801, where additional requests are sent from the control system 120 to the gateway 101, as described in more detail below. If the value of N does correspond to the maximum value of N, at 805, the value of N is reset to 1, as all of the pages (e.g., all of the portions) of the secondary data set have been received by the control system 120.

In the illustrated process 800, different pages of secondary read data (e.g., the secondary data set) that are mapped using the same Modbus registers are simply requested and read one-after-the-other in round-robin fashion. This results in a plurality of second requests as described in more detail below. However, in alternative implementations, additional logic and load balancing methods can be introduced to determine which page number of data to request and receive in the current communication transaction cycle. Also, in alternative implementations, data can be further divided based on relative priority. For example, some data could be designated as “tertiary” data and handled by a separate processing flow that requests and receives tertiary data less frequently or in smaller or larger portions (e.g., by introducing longer intentional delays between request/read cycles) than the secondary data (which in turn is requested and read less frequently or in smaller portions than primary data).

Referring back to FIGS. 5 and 7, the communication link 121 continuously sends requests, such as second requests, and receives data corresponding to the designated protocol registers (R1-R300) of the data sets 501, 502, and 503 of FIG. 5 by reading and writing the relevant values from working memory of control system 120. At the same time, the secondary paged data control module 704 uses page numbers in the data to receive and write secondary read data (portions of the secondary data set) to working memory of the control system 120 for reading by control modules 702 and to receive and write secondary write data to working memory from control modules 702 for sending to the bioprocess controller 131 via the communication link 121.

Referring back to FIG. 6, at 616, the controller at the control system 120 can send a second request to the gateway 101 for data associated with the plurality of bioprocessing instruments of the bioprocessing instrument set 111. The second request can be sent from the control system 120 to the gateway 101 via the communication link 121. The second request can be sent by the control system 120 at a predetermined interval (e.g., every 10 seconds, 30 seconds, one minute, 10 minutes, 30 minutes, one hour, or the like) to the gateway 101. In some implementations, the second request is sent by the control system 120, such as after 704 in FIG. 7, to request additional portions (e.g., pages) of the secondary data set. In such implementations, the second request includes a second identifier associated with a second portion of the secondary data set.

At 618, the gateway 101 can receive the second request for the data associated with the plurality of bioprocessing instruments. The gateway 101 can handle the second request in the same manner as the request received at 604. For example, the gateway 101 can retrieve the requested data from the plurality of bioprocessing instruments. To retrieve the requested data, the gateway 101 can poll the plurality of bioprocessing instruments to request the data. The gateway 101 can poll, at 606, the plurality of bioprocessing instruments at regular and/or predetermined intervals (e.g., every 5 seconds, 10 seconds, 30 seconds, minute, 10 minutes, 30 minutes, hour, and/or the like). The gateway 101 can then store the data in memory of the gateway 101 until the gateway 101 receives the second request at 618. In this example, the stored data can be the data retrieved since the first request was handled at 604. Additionally and/or alternatively, the gateway 101 can poll, at 620, the plurality of bioprocessing instruments for the data in response to receiving the second request at 618.

At 622, the plurality of bioprocessing instruments sends the data to the gateway 101 in response to the poll at 620. In some implementations, both primary data and secondary data is sent from the bioprocessing instruments to the gateway 101 in response to each poll. In other implementations, only primary data is sent from the bioprocessing instruments to the gateway 101, such as when there have been no updates to the secondary data from the previous poll.

At 624, the gateway 101 stores the data received from the plurality of bioprocessing instruments in the memory of the gateway 101, in the same manner as at 610.

At 626, the gateway 101 sends, in response to the second request, the requested data to the controller of the control system 120. The gateway 101 sends the primary data set as a second block of primary data, as described herein. The second block of primary data includes the primary data collected from and/or measured by the plurality of bioprocessing instruments since a previous request (e.g., the request handled at 604) was received and handled by the gateway 101. The primary data set is sent as a second block of primary data to the control system 120 due at least in part to the high priority level of the primary data set. The gateway 101 can cause the controller of the control system 120 to further control at least one bioprocessing instrument of the plurality of bioprocessing instruments by sending the second block of primary data to the control system 120. For example, as described herein, the control system 120 can use the second block of primary data to further adjust one or more operations and/or control at least one of the bioprocessing instruments.

At 626, the gateway 101 further sends the requested second portion of the secondary data set to the control system 120. In other words, the gateway 101 sends the requested second portion of the secondary data set to which the page number N (e.g., the page number following the page number Nat 612; see FIGS. 8 and 10) included in the second request is assigned. Additional requests can be sent including the following page numbers until all of the pages have been exchanged. This helps to reduce the load on the controller of the control system 120 and/or the bioprocess controller 131 as less data is sent from the gateway to the control system 120 and less data is processed by the control system 120 at the same time as the control system 120 is processing the higher priority block of primary data. This can additionally and/or alternatively reduce the computer power needed to process the request because fewer communication protocol addresses are needed to exchange the secondary data set. The second portion of the secondary data set can be sent from the gateway 101 to the control system 120 during the sending of the second block of primary data from the gateway 101 to the control system 120.

At 628, the control system 120 receives the data from the gateway 101 in response to the second request. For example, the control system 120 can receive the second block of primary data. The control system 120 can additionally and/or alternatively receive the second portion of the secondary data set, thereby reducing a processing load on the controller of the control system 120. The control system 120 can receive the second portion of the secondary data set during the receiving of the second block of primary data.

In some implementations, the control system 120 can write data to the gateway 101. In some implementations, the data written to the gateway 101 includes the identifier (e.g., page number) associated with the page N of the portion of the secondary data set requested by the control system 120. Additionally and/or alternatively, the data written to the gateway 101 can include one or more control signals for controlling at least one of the bioprocessing instruments. The gateway 101 can handle the data writing for the page number and the control signal in a similar manner.

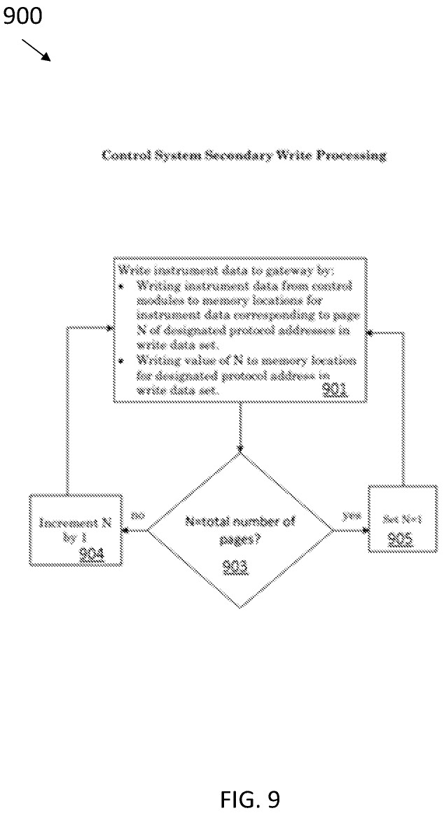

FIG. 9 illustrates a process 900 implemented by the control system 120 for processing secondary write data (e.g., writing secondary data, including an identifier associated with the page number of a requested portion of the secondary data set), consistent with implementations of the current subject matter. At 901, the control system 120 writes data associated with the secondary data to memory array(s) of the control system 120 designated for mapping the data to page N of secondary data corresponding to the communication protocol address designated for secondary write instrument data elements (e.g., protocol addresses R253-300) and also writes the current value of N to the write data set (e.g., third data set 503) using the designated protocol address for write page numbers (e.g., R252).

At 903, the control system 120 (e.g., via the controller of the control system 120) determines whether the value of N corresponding to the portion of the secondary data set being written by the control system 120 is equal to a maximum value of N, i.e., a value corresponding to the total number of pages designated for secondary write data of the secondary data set. If the value of N does not correspond to the maximum value of N, at 904, the value of Nis incremented by 1 and the flow returns to 901, where additional data is written by the control system 120 to the gateway 101, as described in more detail below. If the value of N does correspond to the maximum value of N, at 905, the value of N is reset to 1, as all of the pages (e.g., all of the portions) of the secondary data set have been sent by the control system 120.

Referring back to FIG. 6, at 630, the control system 120 (e.g., via the controller of the control system 120) can control at least one of the bioprocessing instruments, such as by using the received block of primary data and/or the received second block of primary data, and so on. The control system 120 can send a control signal to the gateway 101 of the bioprocess controller 131 for controlling and/or adjusting operation of at least one of the bioprocessing instruments. Additionally and/or alternatively, at 634, the control system 120 (e.g., via the controller of the control system 120) can directly send the control signal to at least one of the bioprocessing instruments to directly control operation of the at least one bioprocessing instrument. Additionally and/or alternatively, the control system 120 can at 630 send the received first block of primary data, second block of primary data, first portion of the secondary data set, second portion of the secondary data set, and so on to the data lake 190 for further analysis and processing. The control system 120 can send at least the first block and second block of primary data and/or the control signal using the primary data output module 703 (see FIG. 7).

At 632, the gateway 101 can write the received write data to the gateway 101 and/or direct the control signal to the at least one bioprocessing instrument. For example, the gateway 101 can, at 632, write the control signal to memory of the gateway 101 or to the control boards that control the relevant instruments, for sending to the bioprocessing instruments and/or can directly transmit the control signal to the bioprocessing instruments.

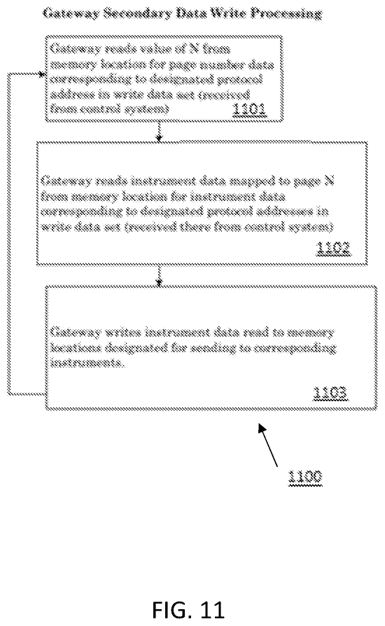

Further, FIG. 11 illustrates a process 1100 implemented by the intelligent gateway 101 for processing secondary write data, including the identifier (e.g., page number N) associated with the portion of the secondary data requested by the control system 120, consistent with implementations of the current subject matter. At 1101, the gateway 101 reads the value of N received from the control system 120 using the corresponding communication protocol data address (e.g., R252 in this example) designated for page numbers of secondary write data. At 1102, the gateway 101 reads the portion of the secondary data set mapped to page N corresponding to the relevant designated protocol addresses (e.g., R253-R300 in this example). At 1103, the gateway 101 writes the page N to memory arrays designated for the relevant instrument data elements where the page number will be sent to the relevant instruments, or to the control boards that control the relevant bioprocessing instruments. The gateway 101 can additionally and/or alternatively write the page number of the written data to secondary read data set using the protocol address designated for sending confirmation of the value of N for currently written data to control system 120 (in this example, protocol address R152 of second data set 502). Processing then returns to 1101 as the gateway 101 continues to receive secondary write data from control system 120, writes it for receipt by corresponding instruments (or instrument control boards), and writes the current value of N for secondary write data, that value being sent to control system 120 as confirmation.

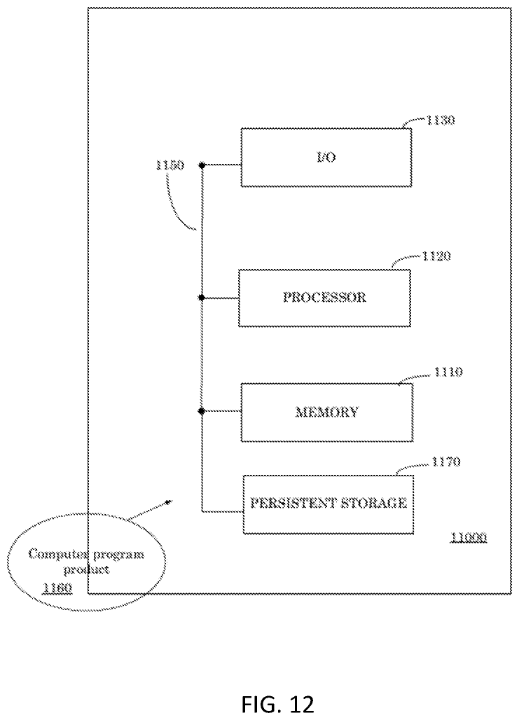

FIG. 12 is a block diagram of a computer system 11000 implementing bioprocess systems and intelligent gateway devices in accordance with exemplary implementations. One or more computer systems 11000 can be used to implement a control system 120 and/or gateway devices 101-104 (control system 120 and gateway devices 101-104 are shown in FIG. 1). Computer system 11000 executes instruction code contained in a computer program product 1160. Computer program product 1160 comprises executable code in an electronically readable medium that can instruct one or more computers such as computer system 11000 to perform processing that accomplishes the exemplary method steps performed by the implementations referenced herein. The electronically readable medium can be any non-transitory medium that stores information electronically and can be accessed locally or remotely, for example via a network connection. In alternative implementations, the medium can be transitory. The medium can include a plurality of geographically dispersed media each configured to store different parts of the executable code at different locations and/or at different times. The executable instruction code in an electronically readable medium directs the illustrated computer system 11000 to carry out various exemplary tasks described herein. The executable code for directing and carrying out tasks and process flows described herein can be realized in software. However, it will be appreciated by those skilled in the art, that computers or other electronic devices might utilize code realized in hardware to perform many or all the identified tasks and disclosed process flows without departing from the present invention. Those skilled in the art will understand that many variations on executable code can be found that implement exemplary methods within the spirit and the scope of the present disclosure.

The code or a copy of the code contained in computer program product 1160 can reside in one or more storage persistent media (not separately shown) communicatively coupled to system 11000 for loading and storage in persistent storage device 1170 and/or memory 1110 for execution by processor 1120. Computer system 11000 also includes I/O subsystem 1130. I/O subsystem 1130, processor 1120, memory 1110, and persistent storage device 1170 are coupled via bus 1150. Like persistent storage device 1170 and any other persistent storage that might contain computer program product 1160, memory 1110 is a non-transitory media (even if implemented as a typical volatile computer memory device). Moreover, those skilled in the art will appreciate that in addition to storing computer program product 1160 for carrying out processing described herein, memory 1110 and/or persistent storage device 1170 can be configured to store the various data elements referenced and illustrated herein.

Those skilled in the art will appreciate computer system 11000 illustrates just one example of a system in which a computer program product in accordance with an implementation of the present disclosure can be implemented. To cite but one example of an alternative implementation, execution of instructions contained in a computer program product in accordance with an implementation of the present disclosure can be distributed over multiple computers, such as, for example, over the computers of a distributed computing network.

While the present exemplary implementations have been described in detail with respect to the illustrated implementations, it will be appreciated that various alterations, modifications, and/or adaptations can be made based on the present disclosure and are intended to be within the scope of the exemplary implementations and present invention. While the invention has been described in connection with what are presently considered to be the most practical and preferred implementations, it is to be understood that the present invention is not limited to the disclosed implementations but, on the contrary, is intended to cover various modifications and equivalent arrangements included within the scope of the underlying principles of the invention as described by the various implementations referenced herein.

What is claimed is:

1. A system, comprising:
at least one data processor; and
a memory storing instructions which, when executed by the at least one data processor, result in operations comprising:
receiving, from a controller configured to control a bioprocessing instrument of a plurality of bioprocessing instruments, a request for data associated with the plurality of bioprocessing instruments, the data comprising:
a primary data set comprising a block of primary data measured by the plurality of bioprocessing instruments; and
a secondary data set having a lower priority than the primary data set;
causing the controller to control the bioprocessing instrument for processing a cell culture containing one or more target biological components by at least: sending, to the controller in response to the request, the block of primary data; and
sending, to the controller during the sending the block of primary data and in response to the request, a portion of the secondary data set, thereby reducing a load on the controller.

2. The system of claim 1, wherein the secondary data set is stored across a plurality of pages, and wherein a page of the plurality of pages contains the portion of the secondary data set.

3. The system of claim 2, wherein the request comprises an identifier identifying the page of the plurality of pages.

4. The system of any one of claims 1 to 3, wherein the block of primary data comprises:
a first parameter measured by at least one of the plurality of bioprocessing instruments, wherein the first parameter is mapped to a first communication protocol address; and
a second parameter measured by at least one of the plurality of bioprocessing instruments, wherein the second parameter is mapped to a second communication protocol address,
wherein the first parameter and the second parameter impact operation of the bioprocessing instrument.

5. The system of any one of claims 1 to 4, wherein the portion of the secondary data set comprises secondary data corresponding to at least two of the plurality of bioprocessing instruments, and wherein the portion of the secondary data set is mapped to a single communication protocol address.

6. The system of any one of claims 1 to 5, wherein the request is a first request; and wherein the operations further comprise:
receiving, from the controller, a second request for data associated with the plurality of bioprocessing instruments after the first request; and
sending, to the controller in response to the second request, a second portion of the secondary data set;
wherein the second request includes a second identifier associated with the second portion.

7. The system of claim 6, wherein the operations further comprise: further causing the controller to control the bioprocessing instrument by at least: sending, to the controller in response to the second request, a second block of primary data measured by the plurality of bioprocessing instruments after the sending the block of primary data, wherein the second portion of the secondary data set is sent during the sending of the second block of primary data.

8. The system of any one of claims 6 to 7, wherein the second request is received at a predetermined interval after the first request.

9. The system of any one of claims 1 to 8, wherein the primary data set comprises operational data associated with the plurality of bioprocessing instruments; and wherein the secondary data set comprises instrument data associated with the plurality of bioprocessing instruments.

10. The system of claim 9, wherein the operational data comprises at least one parameter measured by the plurality of bioprocessing instruments that impacts operation of at least one of the plurality of bioprocessing instruments.

11. The system of any one of claims 9 to 10, wherein the instrument data comprises instrument information about at least one of the plurality of bioprocessing instruments.

12. The system of any one of claims 1 to 11, wherein the priority of the primary data set and the secondary data set is predetermined.

13. The system of any one of claims 1 to 12, wherein the operations further comprise:
receiving the primary data set and the secondary data set from the plurality of bioprocessing instruments;
storing the primary data set in a primary data register, the storing comprising mapping a unique communication protocol address to each parameter in the block of primary data of the primary data set; and
storing the secondary data set in a secondary data register, the storing comprising mapping a single communication protocol address to the portion of the secondary data set, wherein the portion of the secondary data set corresponds to at least two bioprocessing instruments of the plurality of bioprocessing instruments.

14. The system of any one of claims 1 to 13, wherein the operations further comprise:
receiving the primary data set and the secondary data set from the plurality of bioprocessing instruments, wherein at least a portion of the primary data set or the secondary data set has a first unit of measurement; and
converting the first unit of measurement to a second unit of measurement prior to sending the block of primary data or the secondary data set to the controller.

15. A gateway device, the gateway device comprising:
a gateway comprising the at least one data processor and configured to perform the operations of any one of claims 1 to 14;
a control system data communication link communicatively coupled to the controller to facilitate communications between the gateway and the controller using a communication protocol having a plurality of communication protocol addresses; and
an instrument data communication link communicatively coupled to the plurality of bioprocessing instruments to facilitate transmission of the primary data set and the secondary data set from the bioprocessing instrument to the gateway.

16. The gateway device of claim 15, wherein a first communication protocol address of the plurality of communication protocol addresses is mapped to a first parameter of the primary data set; and wherein a second communication protocol address of the plurality of communication protocol addresses is mapped to a plurality of secondary data of the secondary data set.

17. A system, comprising:
at least one data processor; and
a memory storing instructions which, when executed by the at least one data processor, result in operations comprising:
sending a request for data associated with a plurality of bioprocessing instruments, the data comprising:
a primary data set comprising a block of primary data measured by the plurality of bioprocessing instruments; and
a secondary data set having a lower priority than the primary data set;
receiving, in response to the request, the block of primary data;
receiving, in response to the request and during the receiving the block of primary data, a portion of the secondary data set, thereby reducing a computing load for processing the data associated with the plurality of bioprocessing instruments; and
controlling operation of a bioprocessing instrument of the plurality of bioprocessing instruments to process a cell culture containing one or more target biological components based at least on the received block of primary data.

18. The system of claim 17, wherein the secondary data set is stored across a plurality of pages, and wherein a page of the plurality of pages contains the portion of the secondary data set.

19. The system of claim 18, wherein the request comprises an identifier identifying the page of the plurality of pages.

20. The system of any one of claims 17 to 19, wherein the block of primary data comprises:
a first parameter measured by at least one of the plurality of bioprocessing instruments, wherein the first parameter is mapped to a first communication protocol address; and
a second parameter measured by at least one of the plurality of bioprocessing instruments, wherein the second parameter is mapped to a second communication protocol address,
wherein the first parameter and the second parameter impact operation of the bioprocessing instrument.

21. The system of any one of claims 17 to 20, wherein the portion of the secondary data set comprises secondary data corresponding to at least two of the plurality of bioprocessing instruments, and wherein the portion of the secondary data set is mapped to a single communication protocol address.

22. The system of any one of claims 17 to 21, wherein the request is a first request; and wherein the operations further comprise:
sending a second request for data associated with the plurality of bioprocessing instruments after the first request; and
receiving, in response to the second request, a second portion of the secondary data set;
wherein the second request includes a second identifier associated with the second portion.

23. The system of claim 22, wherein the operations further comprise:
receiving, in response to the second request, a second block of primary data measured by the plurality of bioprocessing instruments, wherein the second portion of the secondary data is received during the receiving of the second block of primary data; and
further controlling operation of the bioprocessing instrument based on the second block of primary data.

24. The system of any one of claims 22 to 23, wherein the second request is sent at a predetermined interval after the first request.

25. The system of any one of claims 17 to 24, wherein the primary data set comprises operational data associated with the plurality of bioprocessing instruments; and wherein the secondary data set comprises instrument data associated with the plurality of bioprocessing instruments.

26. The system of claim 25, wherein the operational data comprises at least one parameter measured by the plurality of bioprocessing instruments that impacts operation of at least one of the plurality of bioprocessing instruments.

27. The system of claim 25, wherein the instrument data comprises instrument information about at least one of the plurality of bioprocessing instruments.

28. The system of any one of claims 17 to 27, wherein the priority of the primary data set and the secondary data set is predetermined.

29. The system of any one of claims 17 to 28, wherein the controlling comprises sending a control signal to the bioprocessing instrument.

30. A method, comprising:
receiving, from a controller configured to control a bioprocessing instrument of a plurality of bioprocessing instruments, a request for data associated with the plurality of bioprocessing instruments, the data comprising:
a primary data set comprising a block of primary data measured by the plurality of bioprocessing instruments; and
a secondary data set having a lower priority than the primary data set;
causing the controller to control the bioprocessing instrument for processing a cell culture containing one or more target biological components by at least: sending, to the controller in response to the request, the block of primary data; and
sending, to the controller during the sending the block of primary data and in response to the request, a portion of the secondary data set, thereby reducing a load on the controller.

31. The method of claim 30, wherein the secondary data set is stored across a plurality of pages, and wherein a page of the plurality of pages contains the portion of the secondary data set.

32. The method of claim 31, wherein the request comprises an identifier identifying the page of the plurality of pages.

33. The method of any one of claims 30 to 32, wherein the block of primary data comprises:
a first parameter measured by at least one of the plurality of bioprocessing instruments, wherein the first parameter is mapped to a first communication protocol address; and
a second parameter measured by at least one of the plurality of bioprocessing instruments, wherein the second parameter is mapped to a second communication protocol address,
wherein the first parameter and the second parameter impact operation of the bioprocessing instrument.

34. The method of any one of claims 30 to 33, wherein the portion of the secondary data set comprises secondary data corresponding to at least two of the plurality of bioprocessing instruments, and wherein the portion of the secondary data set is mapped to a single communication protocol address.

35. The method of any one of claims 30 to 34, wherein the request is a first request; and wherein the method further comprises:
receiving, from the controller, a second request for data associated with the plurality of bioprocessing instruments after the first request; and
sending, to the controller in response to the second request, a second portion of the secondary data set;
wherein the second request includes a second identifier associated with the second portion.

36. The method of claim 35, further comprising: further causing the controller to control the bioprocessing instrument by at least: sending, to the controller in response to the second request, a second block of primary data measured by the plurality of bioprocessing instruments after the sending the block of primary data, wherein the second portion of the secondary data set is sent during the sending of the second block of primary data.

37. The method of any one of claims 35 to 36, wherein the second request is received at a predetermined interval after the first request.

38. The method of any one of claims 30 to 37, wherein the primary data set comprises operational data associated with the plurality of bioprocessing instruments; and wherein the secondary data set comprises instrument data associated with the plurality of bioprocessing instruments.

39. The method of claim 38, wherein the operational data comprises at least one parameter measured by the plurality of bioprocessing instruments that impacts operation of at least one of the plurality of bioprocessing instruments.

40. The method of any one of claims 38 to 39, wherein the instrument data comprises instrument information about at least one of the plurality of bioprocessing instruments.

41. The method of any one of claims 30 to 40, wherein the priority of the primary data set and the secondary data set is predetermined.

42. The method of any one of claims 30 to 41, further comprising:
receiving the primary data set and the secondary data set from the plurality of bioprocessing instruments;
storing the primary data set in a primary data register, the storing comprising mapping a unique communication protocol address to each parameter in the block of primary data of the primary data set; and
storing the secondary data set in a secondary data register, the storing comprising mapping a single communication protocol address to the portion of the secondary data set, wherein the portion of the secondary data set corresponds to at least two bioprocessing instruments of the plurality of bioprocessing instruments.

43. The method of any one of claims 30 to 42, further comprising:
receiving the primary data set and the secondary data set from the plurality of bioprocessing instruments, wherein at least a portion of the primary data set or the secondary data set has a first unit of measurement; and
converting the first unit of measurement to a second unit of measurement prior to sending the block of primary data or the secondary data set to the controller.

44. A method, comprising:
sending a request for data associated with a plurality of bioprocessing instruments, the data comprising:
a primary data set comprising a block of primary data measured by the plurality of bioprocessing instruments; and
a secondary data set having a lower priority than the primary data set;
receiving, in response to the request, the block of primary data;
receiving, in response to the request and during the receiving the block of primary data, a portion of the secondary data set, thereby reducing a computing load for processing the data associated with the plurality of bioprocessing instruments; and
controlling operation of a bioprocessing instrument of the plurality of bioprocessing instruments to process a cell culture containing one or more target biological components based at least on the received block of primary data.

45. The method of claim 44, wherein the secondary data set is stored across a plurality of pages, and wherein a page of the plurality of pages contains the portion of the secondary data set.

46. The method of claim 45, wherein the request comprises an identifier identifying the page of the plurality of pages.

47. The method of any one of claims 44 to 46, wherein the block of primary data comprises:
a first parameter measured by at least one of the plurality of bioprocessing instruments, wherein the first parameter is mapped to a first communication protocol address; and
a second parameter measured by at least one of the plurality of bioprocessing instruments, wherein the second parameter is mapped to a second communication protocol address,
wherein the first parameter and the second parameter impact operation of the bioprocessing instrument.

48. The method of any one of claims 44 to 47, wherein the portion of the secondary data set comprises secondary data corresponding to at least two of the plurality of bioprocessing instruments, and wherein the portion of the secondary data set is mapped to a single communication protocol address.

49. The method of any one of claims 44 to 48, wherein the request is a first request; and wherein the method further comprises:
sending a second request for data associated with the plurality of bioprocessing instruments after the first request; and
receiving, in response to the second request, a second portion of the secondary data set;
wherein the second request includes a second identifier associated with the second portion.

50. The method of claim 49, further comprising:
receiving, in response to the second request, a second block of primary data measured by the plurality of bioprocessing instruments, wherein the second portion of the secondary data is received during the receiving of the second block of primary data; and
further controlling operation of the bioprocessing instrument based on the second block of primary data.

51. The method of any one of claims 49 to 50, wherein the second request is sent at a predetermined interval after the first request.

52. The method of any one of claims 44 to 51, wherein the primary data set comprises operational data associated with the plurality of bioprocessing instruments; and wherein the secondary data set comprises instrument data associated with the plurality of bioprocessing instruments.

53. The method of claim 52, wherein the operational data comprises at least one parameter measured by the plurality of bioprocessing instruments that impacts operation of at least one of the plurality of bioprocessing instruments.

54. The method of claim 52, wherein the instrument data comprises instrument information about at least one of the plurality of bioprocessing instruments.

55. The method of any one of claims 44 to 54, wherein the priority of the primary data set and the secondary data set is predetermined.

56. The method of any one of claims 44 to 54, wherein the controlling comprises sending a control signal to the bioprocessing instrument.

57. A non-transitory computer-readable medium storing instructions, which when executed by at least one data processor, result in operations comprising:
receiving, from a controller configured to control a bioprocessing instrument of a plurality of bioprocessing instruments, a request for data associated with the plurality of bioprocessing instruments, the data comprising:
a primary data set comprising a block of primary data measured by the plurality of bioprocessing instruments; and
a secondary data set having a lower priority than the primary data set;
causing the controller to control the bioprocessing instrument for processing a cell culture containing one or more target biological components by at least: sending, to the controller in response to the request, the block of primary data; and
sending, to the controller during the sending the block of primary data and in response to the request, a portion of the secondary data set, thereby reducing a load on the controller.

58. A non-transitory computer-readable medium storing instructions, which when executed by at least one data processor, result in operations comprising:
sending a request for data associated with a plurality of bioprocessing instruments, the data comprising:
a primary data set comprising a block of primary data measured by the plurality of bioprocessing instruments; and
a secondary data set having a lower priority than the primary data set;
receiving, in response to the request, the block of primary data;
receiving, in response to the request and during the receiving the block of primary data, a portion of the secondary data set, thereby reducing a computing load for processing the data associated with the plurality of bioprocessing instruments; and
controlling operation of a bioprocessing instrument of the plurality of bioprocessing instruments to process a cell culture containing one or more target biological components based at least on the received block of primary data.
